(19) United States
(12) Patent Application Publication
(10) Pub. No.: US 2003/0088726 A1
(43) Pub. Date: May 8, 2003

(54) Serial scaleable bandwidth interconnect bus

(76) Inventors: Jeff D. Dillabough, Belcarra (CA); Kevin Tymchuk, Vancouver (CA); Maurice Gleeson, Galway (IE); Gordon R. Oliver, Belcarra (CA)

Correspondence Address: ZITO TLP, 26005 RIDGE ROAD, SUITE 203, DAMASCUS, MD, 20872, US

(21) Appl. No.: 10/062,309

(22) Filed: Jan. 31, 2002

(30) Foreign Application Priority Data
Jan. 31, 2001 (CA) 2,333,349

(51) Int. Cl. G06F 13/14

(52) U.S. Cl. 710/305; 370/252

(57) ABSTRACT

The serial scaleable bandwidth interconnect (SBI336S) bus provides a 777.6 MHz point-to-point LVDS serial interface that supports a variety of traffic types including support for Fractional links. 8B/10B coding is used on the serial link to provide codes to transmit additional control information across the serial interface. The SBI336S bus encodes ADD BUS clock master timing from the PHY device to the Link Layer device over the DROP BUS. The SBI336S bus can also provide an in-band communication channel between devices.

### FIELD

This invention relates to a Serial Scaleable Bandwidth Interconnect (SBI336S) bus interface for interconnection of Physical Layer devices with Link Layer devices of a variety of channel densities and payload types.

### BACKGROUND

Typically, an optical fiber, twisted pair electrical or coaxial cable is used for an electrical transmission facility. Such a facility is coupled to a Physical Medium Dependent sublayer (PMD sublayer), which is the lowest sublayer of the two sublayers of the Physical Layer. The Physical Layer (PHY) is the lowest level layer function of the layer functions in the Broadband Integrated Services Digital Network model. The PHY is responsible for typical layer functions, such as bit transfer/reception and bit synchronization. The prior art discloses a general architecture for connecting a facility to a PHY device and to a Link Layer device. An electrical transmission facility is coupled to a Physical Medium Dependent (PMD) layer device and the latter is coupled through a physical link (PHY-link) interface to the Link Layer device. There is a facility interface on the PMD layer device which may be SONET/SDH, DS3 or E3 and which are specified by several National and International standards organizations. The Link Layer device is coupled to the PMD layer device through the PHY-link interface, which consists of an ADD BUS interface that interfaces data flowing from the Link Layer device to the PMD layer device and a DROP BUS interface, which interfaces data flowing from the PMD layer device to the Link Layer device.

There is a need for system designers to flexibly interconnect high-density multi-port PHY devices in a standardized way with multi-channel and multi-function Link Layer devices.

There is also a need for a higher density alternative for existing synchronous computer telephony buses.

There is a need for PHY-link interfaces that interconnect PHY devices, including channelized framers, with Link Layer devices of widely varying channel densities and payload types.

There is also a need for a point-to-point Low Voltage Differential Signaling (LVDS) serial PHY-link interface that supports a variety of traffic types and capabilities. There is also a need for a serial bus that is compatible with a 19.44 MHz bus supporting multipoint-multipoint operation over a wide range of channel densities and payload types.

It is, therefore, an object of this invention to provide an improved serial PHY-link interface that supports a large number of traffic types including Fractional links.

It is a further object of this invention to allow system designers to flexibly interconnect high-density multi-port PHY devices in a standardized way with multi-channel and multi-function Link Layer devices.

It is a further object of this invention to provide a serial PHY-link interface with an in-band communication channel that allows transmission of control information between linked devices.

It is a further object of this invention to provide a higher density alternative for existing synchronous computer telephony buses.

### SUMMARY

The Serial Scaleable Bandwidth Interconnect (SBI336S) bus is a 777.6 MHz point-to-point Low Voltage Differential Signaling (LVDS) serial PHY-link interface that interconnects PHY devices with Link Layer devices and supports a variety of traffic types including support for Fractional links. The SBI336S bus consists of an ADD BUS interface that receives data from a Link Layer device and directs it to a PHY device. There is also a DROP BUS interface that receives data from a PHY device and directs it to a Link Layer device. 8B/10B coding is used on the serial link to provide codes to transmit additional control information across the serial interface. The SBI336S bus encodes the ADD BUS clock master timing from the PHY device to the Link Layer device over the DROP BUS. The SBI336S bus can optionally provide for an in-band communication channel between devices. This channel is intended for devices at one end of the link to control the device at the other end of the link.

### BRIEF DESCRIPTION OF THE DRAWINGS

The invention itself both as to organization and method of operation, as well as additional objects and advantages thereof, will become readily apparent from the following detailed description when read in connection with the accompanying drawings:

FIG. 1 is a schematic block diagram depicting an embodiment of the Scaleable Bandwidth Interconnect (SBI) bus interface;

FIG. 2 is a schematic block diagram depicting the ADD BUS and DROP BUS interfaces of multiple PHY devices connected to multiple Link Layer devices;

FIG. 3 is a functional timing diagram of the DROP BUS for a T1/E1 tributary;

FIG. 4 is a functional timing diagram of the DROP BUS for a DS3/E3 tributary;

FIG. 5 is a functional timing diagram of the DROP BUS for a Fractional rate link;

FIG. 6 is a timing diagram of the DROP BUS interface input timing parameters;

FIG. 7 is a timing diagram of the DROP BUS interface output timing parameters;

FIG. 8 is a timing diagram of the DROP BUS asynchronous interface output timing parameters;

FIG. 9 is a functional timing diagram of the ADD BUS for a DS3/E3 tributary;

FIG. 10 is a functional timing diagram of the ADD BUS for a Fractional rate link;

FIG. 11 is a timing diagram of the ADD BUS interface input timing parameters;

FIG. 12 is a timing diagram of the ADD BUS interface output timing parameters;

FIG. 13 is a timing diagram of the ADD BUS asynchronous interface output timing parameters;

FIG. 14 is a state transition diagram of the SBI336S character alignment state machine;

FIG. 15 is a state transition diagram of the SBI336S frame alignment state machine.

### DETAILED DESCRIPTION OF THE DRAWINGS

Definitions

FACILITY: An optical fiber, twisted pair electrical or coaxial cable electrical transmission facility.

PMD: Physical Medium Dependent Layer.

PHY: Service Independent Physical Layer.

PHY-LINK: Physical Layer to Link Layer electrical interface.

Conventions

The interface where data flows from the Link Layer device to the PHY device is the ADD BUS Interface. The interface where data flows from the PHY device to the Link Layer device is the DROP BUS Interface.

All signals are active high unless denoted by a trailing “B”.

| | |
|---|---|
| SIGNAL | Active High |
| SIGNALB | Active Low |

The most significant bit in all mapping structures is the first bit of the transmission. For example, bit 7 of octet DS0#1 in the T1 framing format is transmitted first, followed by bit 6 of octet DS0#1, and so on down to bit 0 of octet DS0#1.

The term “Link” refers to the link that is multiplexed onto the SBI bus. This is a T1, E1, DS3, E3 or Fractional signal, which is being multiplexed or demultiplexed from the SBI bus. When a Link is multiplexed within the SBI then it is referred to as a tributary.

The term “TVT” refers to Transparent Virtual Tributaries. A TVT1.5 is either a SONET VT1.5 Virtual Tributary or a SDH TU11 Tributary Unit, which is being multiplexed or demultiplexed from the SBI bus. A TVT2 is either a SONET VT2 Virtual Tributary or a SDH TU12 Tributary Unit, which is being multiplexed or demultiplexed from the SBI bus.

This specification describes the SBI, SBI336 and SBI336S, which are PHY-LINK interfaces. The FACILITY interfaces, such as SONET/SDH, DS3 or E3, are defined by several National and International standards organizations. Channelized mappings of the PHY, such as M13 for channelization of the DS3 FACILITY, are also defined by several National and International standards organizations.

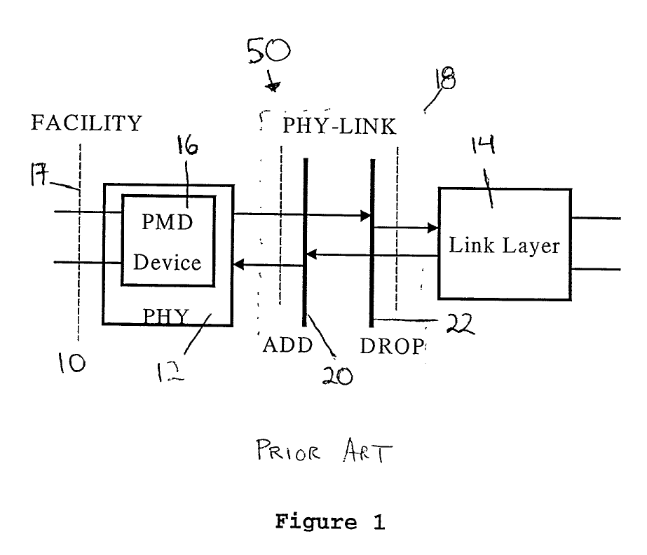

The general architecture 50 for connecting a facility 10 to a PHY device 12 and to a Link Layer device 14 is shown as a schematic block diagram in FIG. 1. The facility 10 is coupled to a physical medium dependent layer (PMD) layer device 16 and the PMD layer device 16 is coupled through a PHY-link interface 18 to the Link Layer device 14. There is a facility interface 17 on the PMD layer device 16 which may be SONET/SDH, DS3 or E3 and is specified by several National and International standards organizations. The Link Layer device 14 is coupled to the PMD layer device 16 through the PHY-link interface 18 which consists of an ADD BUS interface 20 which interfaces data flowing from the Link Layer device 14 to the PMD layer device 16 and a DROP BUS interface 22 which interfaces data flowing from the PMD layer device 16 to the Link Layer device 14. This specification describes the PHY-link interface 18 as an SBI, SBI336 or SBI336S bus.

Specifications

The initial portion of this specification describes a 19.44 MHz bus supporting multipoint-to-multipoint operation. This bus is referred to as the SBI bus.

The second portion describes a 77.76 MHz enhancement to the SBI bus. The 77.76 MHz mode is backward compatible with the 19.44 MHz mode. The lower rate mode is not forward compatible with the higher rate mode. The 77.76 MHz bus will be referred to as the SBI336 bus to reflect the increase in clock speed.

The final portion of the specification describes a serial variant of the SBI336 bus that has the same data transfer capabilities of SBI336 but is not compatible with the byte wide modes described in the SBI specification. The serial variant of the SBI bus is referred to as Serial SBI bus or SBI336S bus.

SBI Specification Summary

This section describes the SBI operation. Portions of the 8-bit 19.44 MHz SBI bus described in Canadian Patent Application No. 2,293,115, laid open Jul. 5, 2000, are specified in this section to provide background details applicable to the 77.76 MHz SBI336 bus and to the 777.6 MHz SBI336S bus.

Bus Widths

The SBI supports an 8-bit wide data bus. A single parity bit is used for the 8-bit data bus. Parity is programmable to be either odd or even. All devices capable of sourcing data onto this bus will use tri-state outputs. In contrast, the SBI336S uses a 1-bit wide data signal.

Clock Rates

The SBI operates at a 19.44 MHz +/−50 ppm clock rate. This clock is common to all devices connecting to a Scaleable Bandwidth Interconnect. There is also a 77.76 Mhz +/−20 ppm clock rate mode specified for the SBI336 bus and a 777.6 MHz clock rate for the SBI336S bus.

Bus Loading

The SBI is shared by multiple PHY devices and multiple Link Layer devices. The maximum number of devices sharing a bus or signal is limited only by the need to meet the AC timing requirements of the bus. All SBI-compatible devices must drive a minimum of eight loads without any form of active termination. A load is defined as an input, output or bi-directional pin and is independent of whether the load is from a PHY device or a Link Layer device.

All SBI compatible devices driving the 19.44 Mhz SBI bus will have a minimum 8 mA drive and must meet timing requirements driving into a 100 pF load with a 10K ohm pullup resistor to 3.3V. SBI timing has been specified to accommodate clock skew between devices of up to 2 ns with minimal loading of the bus. This clock skew can be exceeded with careful system level design.

Schmitt triggers are recommended on all SBI inputs. Pull-up resistors should not be included in any SBI compliant device input but if they are included they must have a disable capability or have a value exceeding 30K Ohms. A weak pull-up resistance exceeding 10K Ohms should be connected to 3.3V on all tri-state bus signals.

Signal Levels

The SBI uses 3.3 v Transistor-Transistor Logic (TTL) signal levels and is not 5V tolerant.

Timing Masters

The SBI is a synchronous bus, which is timed to a reference 19.44 MHz clock and a 2 KHz frame pulse (8 KHz is easily derived from the 2 KHz and 19.44 MHz clock). All sources and sinks of data on this bus are timed to the reference clock and frame pulse.

The data format on the data bus allows for compensating between clock differences on the PHY, SBI and Link Layer devices. This is achieved by floating data structures within the SBI format as discussed below.

Timing is communicated across the SBI by floating data structures within the SBI. Payload indicator signals in the SBI control the position of the floating data structure and therefore the timing. When sources are running faster than the SBI, the floating payload structure is advanced by an octet by passing an extra octet in the V3 octet locations (H3 octet for DS3 and E3 mappings), with the specification of channel mappings detailed below in separate sections for each tributary type. When the source is slower than the SBI, the floating payload is retarded by leaving the octet after the V3 or H3 octet unused. Both of these rate adjustments are indicated by the SBI control signals.

On the DROP BUS, all timing is sourced from the PHY device and is passed onto the Link Layer device by the arrival rate of data over the SBI.

On the ADD BUS, timing can be controlled by either the PHY device or the Link Layer device by controlling the payload and by making justification requests. When the Link Layer device is the timing master the PHY device slaves its transmit timing information from the arrival rate of data across the SBI. When the PHY device is the timing master it signals the Link Layer device to speed up or slow down with justification request signals. The PHY timing master indicates a speedup request to the Link Layer device by asserting the justification request signal (AJUST₁₃ REQ) high during the V3 or H3 octet. When the Link Layer device detects this signal it will advance the channel by inserting data in the next V3 or H3 octet as described above. The PHY timing master indicates a slowdown request to the Link Layer by asserting the justification request signal high during the octet after the V3 or H3 octet. When the Link Layer detects this signal it will retard the channel by leaving the octet following the next V3 or H3 octet unused. Both advance and retard rate adjustments take place in the frame or multi-frame following the justification request.

Jitter

The SBI bus is a time division multiplexed bus and as such, introduces jitter into the transported signal. Although ideal for data communications applications, it may only be suitable for some jitter sensitive applications with additional jitter attenuation circuitry.

Fractional link support is only intended for data communications applications where sensitivity to jitter is not required, therefore it is not described in this section.

This specification provides a method for carrying link rate information across the SBI. This is optional on a per link basis. Two methods are specified, one for T1 and E1 links and the second for DS3 and E3 links. Link rate information is not available for TVTs. These methods use the reference 19.44 MHz SBI clock and the C1FP frame synchronization signal to measure channel clock ticks and clock phase for transport across the bus.

The T1/E1 method allows for a count of the number of T1/E1 rising clock edges between two C1FP frame pulses. This count is encoded in the clock count, ClkRate[1:0], to indicate that the nominal number of clocks, one more than nominal or one less than nominal should be generated during the C1FP period. This method also counts the number of 19.44 MHz clock rising edges after sampling C1FP high to the next rising edge of the T1/E1 clock, giving the ability to control the phase of the generated clock. The link rate information passed across the SBI bus via the V4 octet in the T1/E1 method, which corresponds to the general Linkrate Octet, is shown in Table 1.

TABLE 1
Ti/E1 Link Rate Information

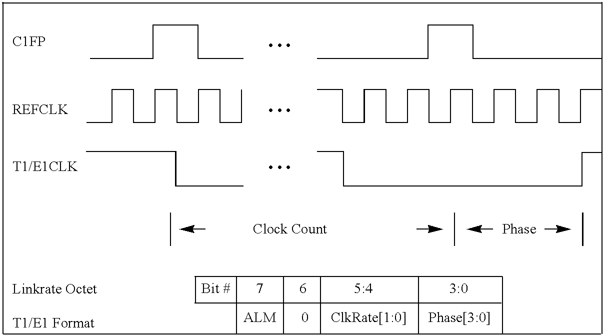

Table 2 shows the encoding of the clock count, ClkRate[1:0], passed in the Linkrate octet.

TABLE 2
T1/E1 Clock Rate Encoding

| ClkRate [1:0] | T1 Clocks/2 KHz | E1 Clocks/2 KHz |
|---|---|---|
| “00”-Nominal | 772 | 1024 |
| “01”-Fast | 773 | 1025 |
| “1x”-Slow | 771 | 1023 |

The DS3 and E3 method for transferring link rate information across the SBI passes the encoded count of DS3/E3 clocks between C1FP pulses in the same method used for T1/E1 tributaries, but does not pass any phase information. The other difference from T1/E1 link rate is that ClkRate[1:0] indicates whether the nominal number of clocks are generated or if four fewer or four extra clocks are generated during the C1FP period. The format of the DS3/E3 Linkrate octet is shown in Table 3. This is passed across the SBI as detailed in Table 13 and Table 16.

TABLE 3
DS3/E3 Link Rate Information

| Linkrate Octet | Bit # | 7 | 6 | 5:4 | 3:0 |
|---|---|---|---|---|---|
| DS3/E3 Format | | ALM | 0 | ClkRate [1:0] | Unused |

Table 4 shows the encoding of the clock count, ClkRate[1:0], passed in the Linkrate octet.

TABLE 4
DS3/E3 Clock Rate Encoding

| ClkRate [1:0] | DS3 Clocks/2 KHz | E3 Clocks/2 KHz |
|---|---|---|
| “00”-Nominal | 22368 | 17184 |
| “01”-Fast | 22372 | 17188 |
| “1x”-Slow | 22364 | 17180 |

Alarms

This specification provides a method for transferring alarm conditions across the SBI bus. This is optional on a per link basis and is valid for T1, E1, DS3, and E3 links but not valid for TVTs or Fractional links.

Table 1 and Table 3 show the alarm indication bit, ALM, as bit 7 of the Linkrate Octet. Devices which do not support alarm indications should set this bit to 0. When not enabled the value of this bit must be ignored by the receiving device.

The presence of an alarm condition is indicated by the ALM bit set high in the Linkrate Octet. The absence of an alarm condition is indicated by the ALM bit set low in the Linkrate Octet. Any actions resulting from the presence of this alarm condition are outside the scope of this specification.

Interface Example

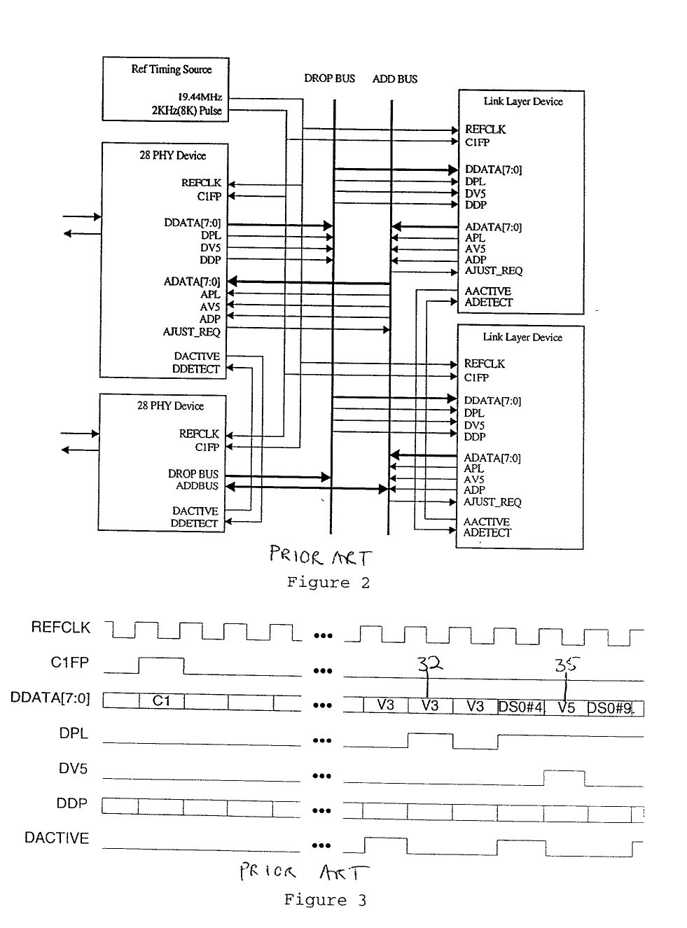

FIG. 2 is a schematic block diagram depicting the interconnections of multiple PHY devices with multiple Link Layer devices across an SBI bus. Each PHY device and each Link Layer device can support multiple links.

Interface Structure

The SBI multiplexing structure is modeled on the SONET/SDH standards.

Supported Interfaces

The SBI bus structure is intended to interconnect various PHY devices with Link Layer devices. Therefore, the interfaces that must be supported over an SBI bus are varied over a wide range of rates and requirements. Table 5 summarizes the links that are supported within an SBI bus structure. The SBI bus provides a lossless interconnect between PHY devices and Link Layer devices when using floating structures. Synchronous applications are supported using locked payloads, common reference clocks and elastic stores. Channel Associated Signaling (CAS) support over T1/E1 links is only mandatory when a link is in synchronous mode using locked payloads.

TABLE 5
Supported Links

| Link | Mapping | Timing Method | Channels |
|---|---|---|---|
| DS3 | Unchannelized DS3 | Floating Payload | 3 |
| E3 | Unchannelized E3 | Floating Payload | 3 |
| T1 | Byte Synchronous | Floating Payload | 84 |
| | | or Locked Payload | |
| E1 | Byte Synchronous | Floating Payload | 63 |
| | | or Locked Payload | |
| TVT1.5 | Transparent | Floating TVT or | 84 |
| | | Locked TVT | |
| TVT2 | Transparent | Floating TVT or | 63 |
| | | Locked TVT | |
| Fractional | Byte stream | Valid Data | 3 |
| | | Indicator | |

SBI Multiplexing Structure

The SBI bus uses the SONET/SDH virtual tributary structure to carry T1 links, E1 links and TVTs. Unchannelized DS3 and E3 payloads follow a byte synchronous structure modeled on the SONET/SDH format.

The SBI structure uses a locked SONET/SDH structure fixing the position of the TU-3 relative to the STS-3/STM-1. The SBI is also of fixed frequency and alignment as determined by the reference clock (REFCLK) and frame indicator signal (C1FP). Frequency deviations are compensated by adjusting the location of the T1/E1/DS3/E3/TVT1.5/TVT2 channels using floating tributaries as determined by the V5 indicator and payload signals (DV5, AV5, DPL and APL) . TVTs also allow for synchronous operation where SONET/SDH tributary pointers are carried within the SBI structure in place of the V5 indicator and payload signals (DV5, AV5, DPL and APL). Fractional links use as many bytes as required within a given Synchronous Payload Envelope (SPE) using the payload signals to indicate bytes carrying valid data.

Table 6 shows the bus structure for carrying T1, E1, TVT1.5, TVT2, DS3, E3 and Fractional tributaries in a SDH STM-1-like format. Up to 84 T1s, 63 E1s, 84 TVT1.5s, 63 TVT2s, 3 DS3s, 3 E3s or 3 Fractional links are carried within the octets labeled SPE1, SPE2 and SPE3 in columns 16-270. All other octets are unused and are of fixed position. The frame signal (C1FP) occurs during the octet labeled C1 in Row 1 column 7.

TABLE 6
Structure for Carrying Multiplexed Links

| | | SBI Column # | | | | | | | | | | | | | | |
|---|---|---|---|---|---|---|---|---|---|---|---|---|---|---|---|---|
| | | 1 | | 6 | 7 | 8 | | 15 | 16 | 17 | 18 | 19 | | 268 | 269 | 270 |
| Row | 1 | — | ●●● | — | C1 | — | ●●● | — | SPE1 | SPE2 | SPE3 | SPE1 | ●●● | SPE1 | SPE2 | SPE3 |
| | 2 | — | ●●● | — | — | — | ●●● | — | SPE1 | SPE2 | SPE3 | SPE1 | ●●● | SPE1 | SPE2 | SPE3 |
| | 9 | — | | — | — | — | | — | SPE1 | SPE2 | SPE3 | SPE1 | | SPE1 | SPE2 | SPE3 |
| | | 1 | | 2 | 3 | 3 | | 5 | 6 | 6 | 6 | 7 | | 90 | 90 | 90 |

SPE Column #

The multiplexed links are separated into three Synchronous Payload Envelopes (SPEs) called SPE1, SPE2 and SPE3. Each envelope carries up to 28 T1s, 21 E1, 28 TVT1.5s, 21 TVT2s, a DS3, an E3 or a Fractional link. SPE1 carries the T1s numbered (1,1) through (1,28), E1s numbered (1,1) through (1,21), DS3 number (1,1), E3 number (1,1) or Fractional link (1,1). SPE2 carries T1s numbered (2,1) through (2,28), E1s numbered (2,1) through (2,21), DS3 number (2,1), E3 number (2,1) or Fractional link (2,1). SPE3 carries T1s numbered (3,1) through (3,28), E1s numbered (3,1) through (3,21), DS3 number (3,1), E3 number (3,1) or Fractional link (3,1). TVT1.5s are numbered the same as T1 tributaries and TVT2s are numbered the same as E1 tributaries.

The mappings for each link type are rigidly defined, however the mix of links transported across the bus at any one time is flexible. Each SPE, comprising 85 columns numbered 6 through 90, operates independently allowing a mix of T1s, E1s, TVT1.5s, TVT2s, DS3s, E3s or Fractional links. For example, SPE1 could transport a single DS3, SPE2 could transport a single E3 and SPE3 could transport either 28 T1s or 21 E1s. Each SPE is restricted to carrying a single tributary type. SBI columns 16-18 are unused for T1, E1, TVT1.5 and TVT2 tributaries.

Tributary numbering for T1/E1 uses the SPE number followed by the tributary number within that SPE and is numbered sequentially.

Table 7 and Table 8 show the T1 and E1 column numbering and relate the tributary number to the SPE column numbers and overall SBI column structure. Numbering for DS3 or E3 follow the same naming convention even though there is only one DS3 or E3 per SPE. TVT1.5s and TVT2s follow the same numbering conventions as T1 and E1 tributaries respectively.

TABLE 7
T1/TVT1.5 Tributary Column Numbering

| T1 # | SPE1 Column | SPE2 Column | SPE3 Column | SBI Column |
|---|---|---|---|---|
| 1, 1 | 7, 35, 63 | | | 19, 103, 187 |
| 2, 1 | | 7, 35, 63 | | 20, 104, 188 |
| 3, 1 | | | 7, 35, 63 | 21, 105, 189 |
| 1, 2 | 8, 36, 64 | | | 22, 106, 190 |
| 2, 2 | | 8, 36, 64 | | 23, 107, 191 |
| . . . | | | | |
| 1, 28 | 34, 62, 90 | | | 100, 184, 268 |
| 2, 28 | | 34, 62, 90 | | 101, 185, 269 |
| 3, 28 | | | 34, 62, 90 | 102, 186, 270 |

TABLE 8
E1/TVT2 Tributary Column Numbering

| | SPE1 | | | |
|---|---|---|---|---|
| E1 # | Column | SPE2 Column | SPE3 Column | SBI Column |
| 1, 1 | 7, 28, 49, | | | 19, 82, 145, 208 |
| | 70 | | | |
| 2, 1 | | 7, 28, 49, 70 | | 20, 83, 146, 209 |
| 3, 1 | | | 7, 28, 49, 70 | 21, 84, 147, 210 |
| 1, 2 | 8, 29, 50, | | | 22, 85, 148, 211 |
| | 71 | | | |
| 2, 2 | | 8, 29, 50, 71 | | 23, 86, 149, 212 |
| . . . | | | | |
| 1, 21 | 27, 48, 69, | | | 79, 142, 205, 268 |
| | 90 | | | |
| 2, 21 | | 27, 48, 69, 90 | | 80, 143, 206, 269 |
| 3, 21 | | | 27, 48, 69, 90 | 81, 144, 207, 270 |

T1 Tributary Mapping

Table 9 shows the format for mapping 84 T1s within the SPE octets. The DS0s and framing bits within each T1 are easily located within this mapping for channelized T1 applications. It is acceptable for the framing bit to not carry a valid framing bit on the ADD BUS since the PHY will provide this information. Unframed T1s use the same format for mapping 84 T1s into the SEI except that the T1 tributaries need not align with the frame bit and DS0 locations. The V1, V2 and V4 octets are not used to carry T1 data and are either reserved or used for control across the interface. When enabled, the V4 octet is the Linkrate octet shown in Table 1. It carries alarm and clock phase information across the SBI bus. The V1 and V2 octets are unused and should be ignored by devices listening to the SBI bus. The V5 and R octets do not carry any information and are fixed to a zero value. The V3 octet carries a T1 data octet but only during rate adjustments as indicated by the V5 indicator signals, DV5 and AV5, and payload signals, DPL and APL. The PPSSSSFR octets carry CAS bits and the T1 framing overhead. The DS0 octets are the 24 DS0 channels making up the T1 link.

TABLE 9
T1 Framing Format

| | | | T1#2, | | T1#2, | | T1#2, |
|---|---|---|---|---|---|---|---|
| | COL # | T1#1,1 | 1-3,28 | T1#1,1 | 1-3,28 | T1#1,1 | 1-3,28 |
| ROW | 1-18 | 19 | 20-102 | 103 | 104-186 | 187 | 188-270 |
| 1 | Unused | V1 | V1 | 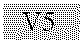 | — | 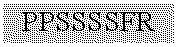 | — |
| 2 | Unused | 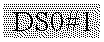 | — | 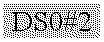 | — | 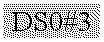 | — |
| 3 | Unused | 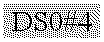 | — | 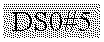 | — | 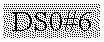 | — |
| 4 | Unused | 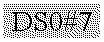 | — | 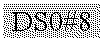 | — | 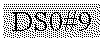 | — |
| 5 | Unused | 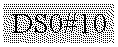 | — | 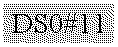 | — | 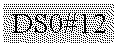 | — |
| 6 | Unused | 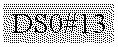 | — | 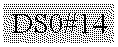 | — | 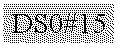 | — |
| 7 | Unused | 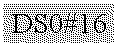 | — | 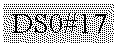 | — | 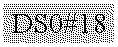 | — |
| 8 | Unused | 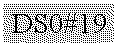 | — | 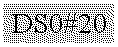 | — | 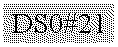 | — |
| 9 | Unused | 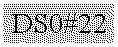 | — | 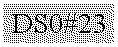 | — | 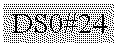 | — |
| 1 | Unused | V2 | V2 | 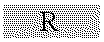 | — | 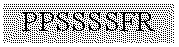 | — |
| 2 | Unused | 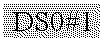 | — | 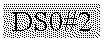 | — | 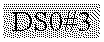 | — |
| 3 | Unused | 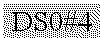 | — | 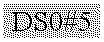 | — | 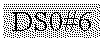 | — |
| 4 | Unused | 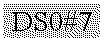 | — | 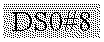 | — | 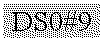 | — |
| 5 | Unused | 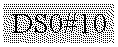 | — | 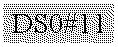 | — | 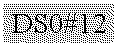 | — |
| 6 | Unused | 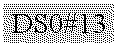 | — | 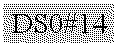 | — | 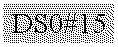 | — |
| 7 | Unused | 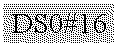 | — | 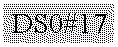 | — | 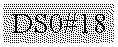 | — |
| 8 | Unused | 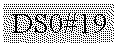 | — | 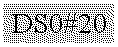 | — | 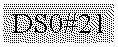 | — |
| 9 | Unused | 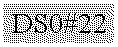 | — | 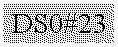 | — | 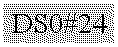 | — |
| 1 | Unused | V3 | V3 | 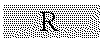 | — | 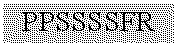 | — |
| 2 | Unused | 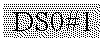 | — | 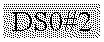 | — | 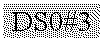 | — |
| 3 | Unused | 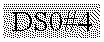 | — | 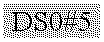 | — | 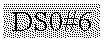 | — |
| 4 | Unused | 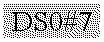 | — | 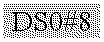 | — | 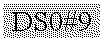 | — |
| 5 | Unused | 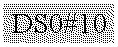 | — | 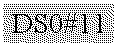 | — | 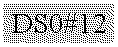 | — |
| 6 | Unused | 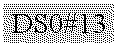 | — | 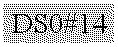 | — | 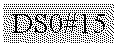 | — |
| 7 | Unused | 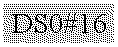 | — | 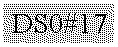 | — | 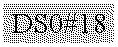 | — |
| 8 | Unused | 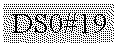 | — | 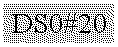 | — | 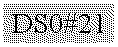 | — |
| 9 | Unused | 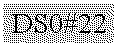 | — | 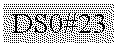 | — | 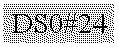 | — |
| 1 | Unused | V4 | V4 | 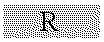 | — | 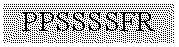 | — |
| 2 | Unused | 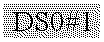 | — | 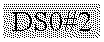 | — | 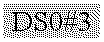 | — |
| 3 | Unused | 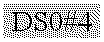 | — | 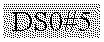 | — | 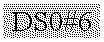 | — |
| 4 | Unused | 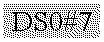 | — | 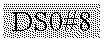 | — | 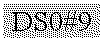 | — |
| 5 | Unused | 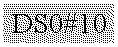 | — | 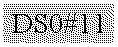 | — | 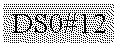 | — |
| 6 | Unused | 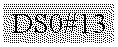 | — | 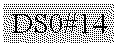 | — | 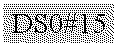 | — |
| 7 | Unused | 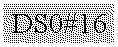 | — | 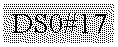 | — | 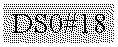 | — |
| 8 | Unused | 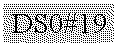 | — | 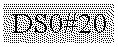 | — | 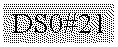 | — |
| 9 | Unused | 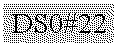 | — | 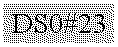 | — | 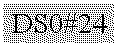 — | |

The V1, V2, V3 and V4 octets are fixed to the locations shown. All the other octets, shown shaded for T1#1,1 (see Table 9), float within the allocated columns maintaining the same order and moving a maximum of one octet per 2 KHz multi-frame. The position of the floating T1 is identified via the V5 indicator signals, DV5 and AV5, which locate the V5 octet. When the T1 tributary rate is faster than the SBI nominal T1 tributary rate, the T1 tributary is shifted ahead by one octet, which is compensated by sending an extra octet in the V3 location. When the T1 tributary rate is slower than the nominal SBI tributary rate the T1 tributary is shifted by one octet which is compensated by inserting a stuff octet in the octet immediately following the V3 octet and delaying the octet that was originally in that position.

The P₁P₀S₁S₂S₃S₄FR octet carries T1 framing in the F bit and CAS in the P₁P₀ and S₁S₂S₃S₄ bits. CAS is optional and when supported is only mandatory in locked (synchronous) timing mode. The R bit is reserved and is set to 0. The P₁P₀ bits are used to indicate the phase of the CAS, and the S₁S₂S₃S₄ bits are the CAS bits for the 24 DS0 channels in the T1. Table 10 shows the CAS bit mapping and how the phase bits locate the sixteen state CAS mapping as well as T1 frame alignment for super frame and extended superframe formats. When using four state CAS then the signaling bits are A1-A24, B1-B24 in place of A1-A24, B1-B24, C1-C24, D1-D24. When using two state CAS there are only A1-A24 signaling bits.

TABLE 10
T1 Channel Associated Signaling (CAS) bits

| | | | | SF | ESF | |
|---|---|---|---|---|---|---|
| S₁ | S₂ | S₃ | S₄ | F | F | P₁ P₀ |
| A1 | A2 | A3 | A4 | F1 | M1 | 00 |
| A5 | A6 | A7 | A8 | S1 | C1 | 00 |
| A9 | A10 | A11 | A12 | F2 | M2 | 00 |
| A13 | A14 | A15 | A16 | S2 | F1 | 00 |
| A17 | A18 | A19 | A20 | F3 | M3 | 00 |
| A21 | A22 | A23 | A24 | S3 | C2 | 00 |
| B1 | B2 | B3 | B4 | F4 | M4 | 01 |
| B5 | B6 | B7 | B8 | S4 | F2 | 01 |
| B9 | B10 | B11 | B12 | F5 | M5 | 01 |
| B13 | B14 | B15 | B16 | S5 | C3 | 01 |
| B17 | B18 | B19 | B20 | F6 | M6 | 01 |
| B21 | B22 | B23 | B24 | S6 | F3 | 01 |
| C1 | C2 | C3 | C4 | F1 | M7 | 10 |
| C5 | C6 | C7 | C8 | S1 | C4 | 10 |
| C9 | C10 | C11 | C12 | F2 | M8 | 10 |
| C13 | C14 | C15 | C16 | S2 | F4 | 10 |
| C17 | C18 | C19 | C20 | F3 | M9 | 10 |
| C21 | C22 | C23 | C24 | S3 | C5 | 10 |
| D1 | D2 | D3 | D4 | F4 | M10 | 11 |
| D5 | D6 | D7 | D8 | S4 | F5 | 11 |
| D9 | D10 | D11 | D12 | F5 | M11 | 11 |
| D13 | D14 | D15 | D16 | S5 | C6 | 11 |
| D17 | D18 | D19 | D20 | F6 | M12 | 11 |
| D21 | D22 | D23 | D24 | S6 | F6 | 11 |

T1 tributary asynchronous timing is compensated via the V3 octet. T1 tributary link rate adjustments are optionally passed across the SBI via the V4 octet, and T1 tributary alarm conditions are optionally passed across the SBI bus via the Linkrate octet in the V4 location as previously described.

The SBI bus allows for a synchronous T1 mode of operation, which is required when supporting CAS signaling. In this mode, the T1 tributary mapping is fixed to that shown in Table 9 and rate justifications are not possible using the V3 octet. The clock rate information within the Linkrate octet in the V4 location is not used in synchronous mode.

E1 Tributary Mapping

Table 11 shows the format for mapping 63 E1s within the SPE octets. The timeslots and framing bits within each E1 are easily located within this mapping for channelized E1 applications. It is acceptable for the framing bits to not carry valid framing information on the ADD BUS since the PHY will provide this information. Unframed E1s use the same format for mapping 63 E1s into the SBI except that the E1 tributaries need not align with the timeslot locations associated with channelized E1 applications. The V1, V2 and V4 octets are not used to carry E1 data and are either reserved or used for control information across the interface. When enabled, the V4 octet carries clock phase information across the SBI. The V1 and V2 octets are unused and should be ignored by devices listening to the SBI bus. The V5 and R octets do not carry any information and are fixed to a zero value. The V3 octet carries an E1 data octet but only during rate adjustments as indicated by the V5 indicator signals, DV5 and AV5, and payload signals, DPL and APL. The PP octets carry CAS phase information and E1 frame alignment. TS#0 through TS#31 make up the E1 channel.

TABLE 11
E1 Framing Format

| | | E1# | #2, | E1# | #2, | E1# | #2, | E1# | #2, |
|---|---|---|---|---|---|---|---|---|---|
| | COL # | 1,1 | 1-3,21 | 1,1 | 1-3,21 | 1,1 | 1-3,21 | 1,1 | 1-3,21 |
| ROW | 1-18 | 19 | 20-81 | 82 | 83-144 | 145 | 146-207 | 208 | 209-270 |
| 1 | Unused | V1 | V1 | 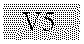 | — | 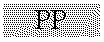 | — | 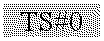 | — |
| 2 | Unused | 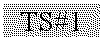 | — | 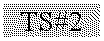 | — | 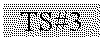 | — | 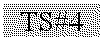 | — |
| 3 | Unused | 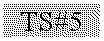 | — | 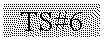 | — | 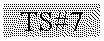 | — | 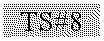 | — |
| 4 | Unused | 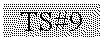 | — | 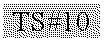 | — | 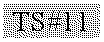 | — | 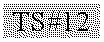 | — |
| 5 | Unused | 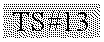 | — | 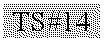 | — | 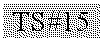 | — | 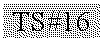 | — |
| 6 | Unused | 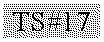 | — | 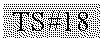 | — | 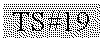 | — | 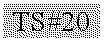 | — |
| 7 | Unused | 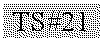 | — | 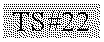 | — | 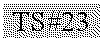 | — | 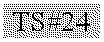 | — |
| 8 | Unused | 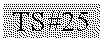 | — | 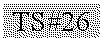 | — | 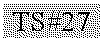 | — | 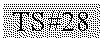 | — |
| 9 | Unused | 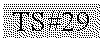 | — | 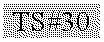 | — | 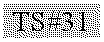 | — | 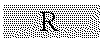 | — |
| 1 | Unused | V2 | V2 | 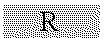 | — | 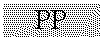 | — | 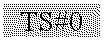 | — |
| 2 | Unused | 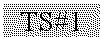 | — | 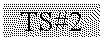 | — | 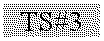 | — | 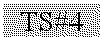 | — |
| 3 | Unused | 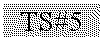 | — | 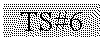 | — | 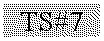 | — | 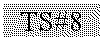 | — |
| 4 | Unused | 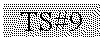 | — | 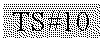 | — | 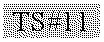 | — | 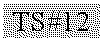 | — |
| 5 | Unused | 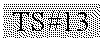 | — | 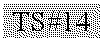 | — | 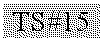 | — | 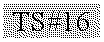 | — |
| 6 | Unused | 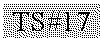 | — | 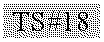 | — | 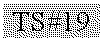 | — | 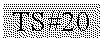 | — |
| 7 | Unused | 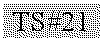 | — | 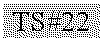 | — | 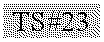 | — | 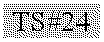 | — |
| 8 | Unused | 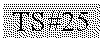 | — | 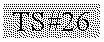 | — | 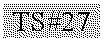 | — | 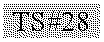 | — |
| 9 | Unused | 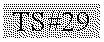 | — | 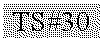 | — | 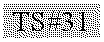 | — | 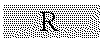 | — |
| 1 | Unused | V3 | V3 | 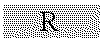 | — | 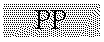 | — | 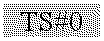 | — |
| 2 | Unused | 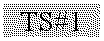 | — | 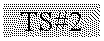 | — | 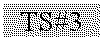 | — | 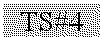 | — |
| 3 | Unused | 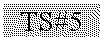 | — | 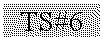 | — | 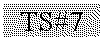 | — | 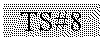 | — |
| 4 | Unused | 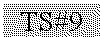 | — | 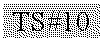 | — | 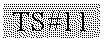 | — | 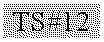 | — |
| 5 | Unused | 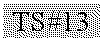 | — | 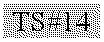 | — | 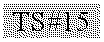 | — | 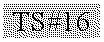 | — |
| 6 | Unused | 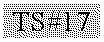 | — | 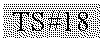 | — | 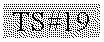 | — | 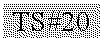 | — |
| 7 | Unused | 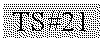 | — | 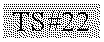 | — | 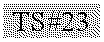 | — | 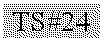 | — |
| 8 | Unused | 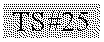 | — | 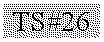 | — | 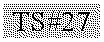 | — | 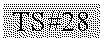 | — |
| 9 | Unused | 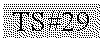 | — | 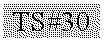 | — | 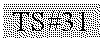 | — | 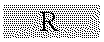 | — |
| 1 | Unused | V4 | V4 | 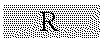 | — | 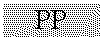 | — | 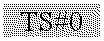 | — |
| 2 | Unused | 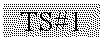 | — | 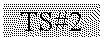 | — | 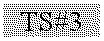 | — | 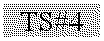 | — |
| 3 | Unused | 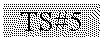 | — | 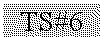 | — | 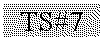 | — | 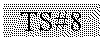 | — |
| 4 | Unused | 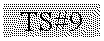 | — | 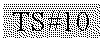 | — | 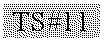 | — | 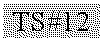 | — |
| 5 | Unused | 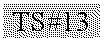 | — | 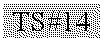 | — | 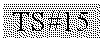 | — | 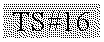 | — |
| 6 | Unused | 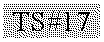 | — | 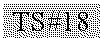 | — | 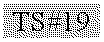 | — | 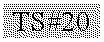 | — |
| 7 | Unused | 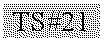 | — | 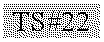 | — | 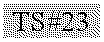 | — | 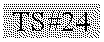 | — |
| 8 | Unused | 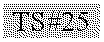 | — | 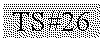 | — | 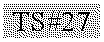 | — | 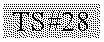 | — |
| 9 | Unused | 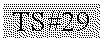 | — | 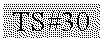 | — | 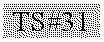 | — | 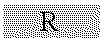 | — |

The V1, V2, V3 and V4 octets are fixed to the locations shown in Table 11. All the other octets, shown shaded for E1#1,1 in Table 11, float within the allocated columns maintaining the same order and moving a maximum of one octet per 2 KHz multi-frame. The position of the floating E1 is identified via the V5 indicator signals, DV5 and AV5, which locate the V5 octet. When the E1 tributary rate is faster than the E1 tributary nominal rate, the E1 tributary is shifted ahead by one octet, which is compensated by sending an extra octet in the V3 location. When the E1 tributary rate is slower than the nominal rate the E1 tributary is shifted by one octet which is compensated by inserting a stuff octet in the octet immediately following the V3 octet and delaying the octet that was originally in that position.

CAS is optional, and when supported is only mandatory in locked (synchronous) timing mode. When using CAS, TS#16 carries the ABCD signaling bits and the timeslots 17 through 31 are renumbered 16 through 30. The PP octet is 0h for all frames except for the frame which carries the CAS for timeslots 15/30 at which time the PP octet is C0h. The first octet of the CAS multi-frame, RRRRRRRR, is reserved and should be ignored by the receiver when CAS signaling is enabled.

Table 12 shows the format of timeslot 16 when carrying CAS bits.

TABLE 12
E1 Channel Associated Signaling (CAS) bits

| TS #16 [7:4] | TS #16 [3:0] | PP |
|---|---|---|
| RRRR | RRRR | 00 |
| ABCD1 | ABCD16 | 00 |
| ABCD2 | ABCD17 | 00 |
| ABCD3 | ABCD18 | 00 |
| ABCD4 | ABCD19 | 00 |
| ABCD5 | ABCD20 | 00 |
| ABCD6 | ABCD21 | 00 |
| ABCD7 | ABCD22 | 00 |
| ABCD8 | ABCD23 | 00 |
| ABCD9 | ABCD24 | 00 |
| ABCD10 | ABCD25 | 00 |
| ABCD11 | ABCD26 | 00 |
| ABCD12 | ABCD27 | 00 |
| ABCD13 | ABCD28 | 00 |
| ABCD14 | ABCD29 | 00 |
| ABCD15 | ABCD30 | 00 |

E1 tributary asynchronous timing is compensated via the V3 octet. E1 tributary link rate adjustments are optionally passed across the SBI via the V4 octet, and E1 tributary alarm conditions are optionally passed across the SBI bus via the Linkrate octet in the V4 location as previously described.

The SBI bus allows for a synchronous E1 mode of operation, which is required when supporting CAS signaling. In this mode, the E1 tributary mapping is fixed to that shown in Table 11 and rate justifications are not possible using the V3 octet. The clock rate information within the Linkrate octet in the V4 location is not used in synchronous mode.

DS3 Tributary Mapping

Table 13 shows a DS3 tributary mapped within the first synchronous payload envelope SPE1. The V5 indicator pulse identifies the V5 octet. The DS3 framing format does not follow an 8 KHz frame period so the floating DS3 multi-frame located by the V5 indicator, shown in heavy border grey region in Table 13, will jump around relative to the H1 frame on every pass. The V5 indicator will often be asserted twice per H1 frame, as is shown by the second V5 octet in Table 13. The V5 indicator and payload signals indicate negative and positive rate adjustments which are carried out by either putting a data byte in the H3 octet or leaving empty the octet after the H3 octet.

TABLE 13
DS3 Framing Format

| | | | SPE COL # | | | | |
|---|---|---|---|---|---|---|---|
| | SBI | | DS3 | DS3 | DS3 | DS3 | DS3 |
| | COL# | | 1 | 2-56 | 57 | 58-84 | Col 85 |
| ROW | 1,4,7,10 | 13 | 16 | . . . | 184 | . . . | 268 |
| 1 | Unused | H1 | 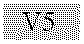 | 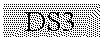 | 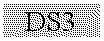 | 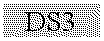 | 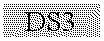 |
| 2 | Unused | H2 | 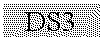 | 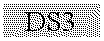 | 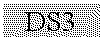 | 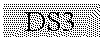 | 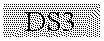 |
| 3 | Unused | H3 | 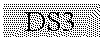 | 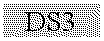 | 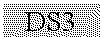 | 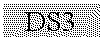 | 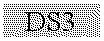 |
| 4 | Unused | Linkrate | 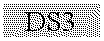 | 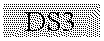 | 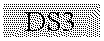 | 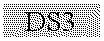 | 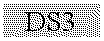 |
| 5 | Unused | Unused | 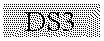 | 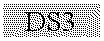 | 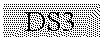 | 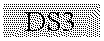 | 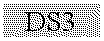 |
| 6 | Unused | Unused | 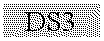 | 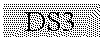 | 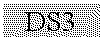 | 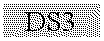 | 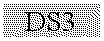 |
| 7 | Unused | Unused | 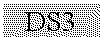 | 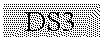 | 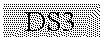 | 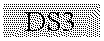 | 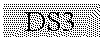 |
| 8 | Unused | Unused | 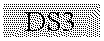 | 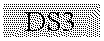 | 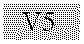 | 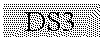 | 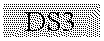 |
| 9 | Unused | Unused | 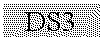 | 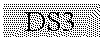 | 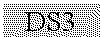 | 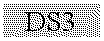 | 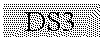 |

As the DS3 tributary rate is less than the rate of the grey region of Table 13, padding octets are interleaved with the DS3 tributary to make up the difference in rate. Interleaved with every DS3 multi-frame are 35 stuff octets, one of which is the V5 octet. These 35 stuff octets are spread evenly across seven DS3 subframes. Each DS3 subframe is eight blocks of 85 bits. The 85 bits making up a DS3 block are padded out to be 11 octets. Table 14 shows the DS3 block 11-octet format where R indicates a stuff bit, F indicates a DS3 framing bit and I indicates DS3 information bits. Table 15 shows the DS3 multi-frame format that is packed into the grey region of Table 13. In table 15, V5 indicates the V5 octet, which is also a stuff octet, R indicates a stuff octet and B indicates the 11-octet DS3 block. Each row in Table 15 is a DS3 multi-frame. The DS3 multi-frame stuffing format is identical for 5 multi-frames and then an extra stuff octet after the V5 octet is added every sixth frame.

TABLE 14
DS3 Block Format

| | | | | | | | | | | | |
|---|---|---|---|---|---|---|---|---|---|---|---|
| Octet | 1 | 2 | 3 | 4 | 5 | 6 | 7 | 8 | 9 | 10 | 11 |
| Data | RRRFIIII | 8*I | 8*I | 8*I | 8*I | 8*I | 8*I | 8*I | 8*I | 8*I | 8*I |

TABLE 15
DS3 Multi-frame Stuffing Format

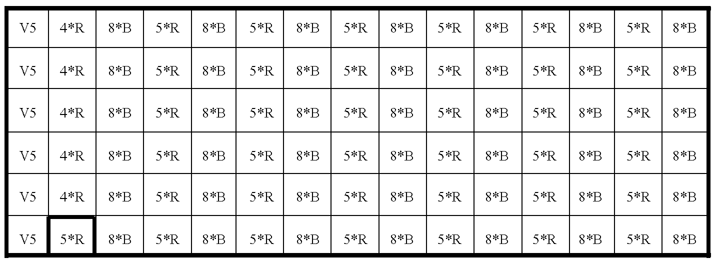

DS3 asynchronous timing is compensated via the H3 octet, DS3 link rate adjustments are optionally passed across the SBI via the Linkrate octet, and DS3 alarm conditions are optionally passed across the SBI bus via the Linkrate octet as previously described.

E3 Tributary Mapping

Table 16 shows an E3 tributary mapped within the first synchronous payload envelope SPE1. The V5 indicator pulse identifies the V5 octet. The E3 framing format does not follow an 8 KHz frame period so the floating frame located by the V5 indicator and shown in grey in Table 16, will jump around relative to the H1 frame on every pass. The V5 indicator will be asserted two or three times per H1 frame, as is shown by the second and third V5 octet in Table 16. The V5 indicator and payload signals indicate negative and positive rate adjustments which are carried out by either putting a data byte in the H3 octet or leaving empty the octet after the H3 octet. As the E3 tributary rate is less than the rate of the grey region of Table 16, padding octets are interleaved with the E3 tributary to make up the difference in rate.

TABLE 16
E3 Framing Format

| | | | SPE COL # | | | | | | |
|---|---|---|---|---|---|---|---|---|---|
| | | | E3 | E3 | E3 | E3 | E3 | E3 | E3 |
| | SBI COL# | | 1 | 2-18 | 19 | 20-38 | 39 | 40-84 | 85 |
| ROW | 1,4,7,10 | 13 | 16 | . . . | 70 | . . . | 130 | . . . | 268 |
| 1 | Unused | H1 | 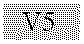 | 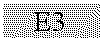 | 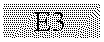 | 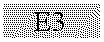 | 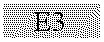 | 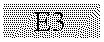 | 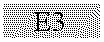 |
| 2 | Unused | H2 | 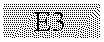 | 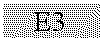 | 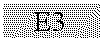 | 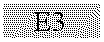 | 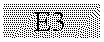 | 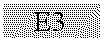 | 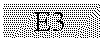 |
| 3 | Unused | H3 | 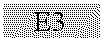 | 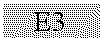 | 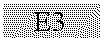 | 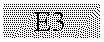 | 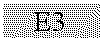 | 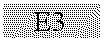 | 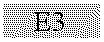 |
| 4 | Unused | Linkrate | 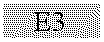 | 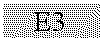 | 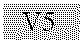 | 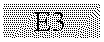 | 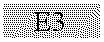 | 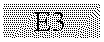 | 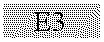 |
| 5 | Unused | Unused | 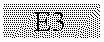 | 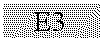 | 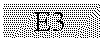 | 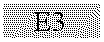 | 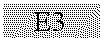 | 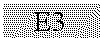 | 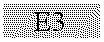 |
| 6 | Unused | Unused | 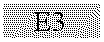 | 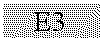 | 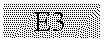 | 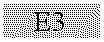 | 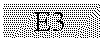 | 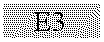 | 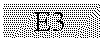 |
| 7 | Unused | Unused | 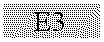 | 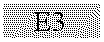 | 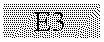 | 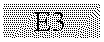 | 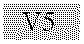 | 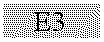 | 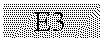 |
| 8 | Unused | Unused | 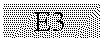 | 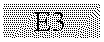 | 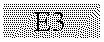 | 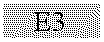 | 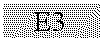 | 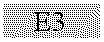 | 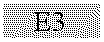 |
| 9 | Unused | Unused | 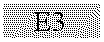 | 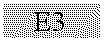 | 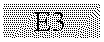 | 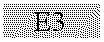 | 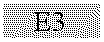 | 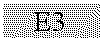 | 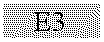 |

Interleaved with every E3 frame is an alternating pattern of 81 and 82 stuff octets, one of which is the V5 octet. These 81 or 82 stuff octets are spread evenly across the E3 frame. Each E3 subframe is 48 octets, which is further broken into 4 equal blocks of 12 octets each. Table 17 shows the alternating E3 frame-stuffing format that is packed into the grey region of Table 16. Note that there are 6 stuff octets after the V5 octet in one frame and 5 stuff octets after the V5 octet in the next frame. In Table 17, V5 indicates the V5 octet, which is also a stuff octet, R indicates a stuff octet, D indicates an E3 data octet, and FAS indicates the first byte of the 10-bit E3 Frame Alignment Signal.

TABLE 17
E3 Frame Stuffing Format

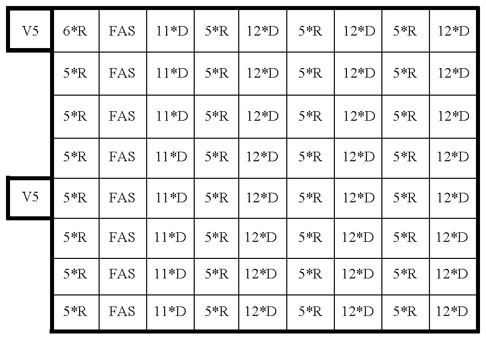

E3 asynchronous timing is compensated via the H3 octet, E3 link rate adjustments are optionally passed across the SBI via the Linkrate octet, and E3 alarm conditions are optionally passed across the SBI bus via the Linkrate octet as previously described.

Transparent VT1.5/TU11 Mapping

VT1.5 and TU11 virtual tributaries, also referred to as TVT1.5, are transported across the SBI bus in a similar manner to the T1 tributary mapping. Table 18 shows the transparent structure where “I” is used to indicate information bytes. There are two options when carrying virtual tributaries on the SBI bus, locked TVT mode and floating TVT mode, the primary difference being how the floating V5 payload is located.

TABLE 18
Transparent VT1.5/TU11 Format

| | | VT1.5 | #2, | VT1.5 | #2, | VT1.5 | #2, |
|---|---|---|---|---|---|---|---|
| | COL | #1,1 | 1-3,28 | #1,1 | 1-3,28 | #1,1 | 1-3,28 |
| ROW # | 1-18 | 19 | 20-102 | 103 | 104-186 | 187 | 188-270 |
| 1 | Unused | 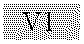 | V1 | 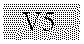 | — | 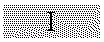 | — |
| 2 | Unused | 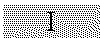 | — | 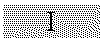 | — | 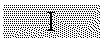 | — |
| 3 | Unused | 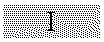 | — | 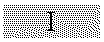 | — | 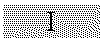 | — |
| 4 | Unused | 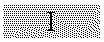 | — | 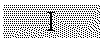 | — | 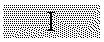 | — |
| 5 | Unused | 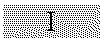 | — | 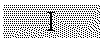 | — | 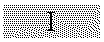 | — |
| 6 | Unused | 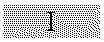 | — | 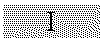 | — | 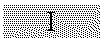 | — |
| 7 | Unused | 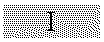 | — | 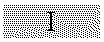 | — | 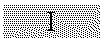 | — |
| 8 | Unused | 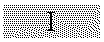 | — | 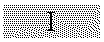 | — | 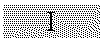 | — |
| 9 | Unused | 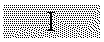 | — | 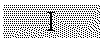 | — | 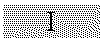 | — |
| 1 | Unused | 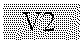 | V2 | 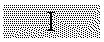 | — | 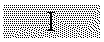 | — |
| 2 | Unused | 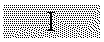 | — | 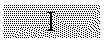 | — | 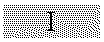 | — |
| 3 | Unused | 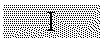 | — | 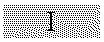 | — | 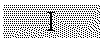 | — |
| 4 | Unused | 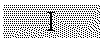 | — | 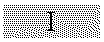 | — | 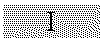 | — |
| 5 | Unused | 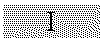 | — | 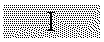 | — | 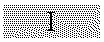 | — |
| 6 | Unused | 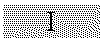 | — | 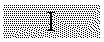 | — | 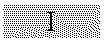 | — |
| 7 | Unused | 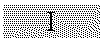 | — | 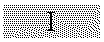 | — | 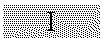 | — |
| 8 | Unused | 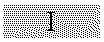 | — | 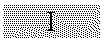 | — | 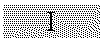 | — |
| 9 | Unused | 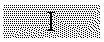 | — | 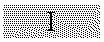 | — | 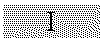 | — |
| 1 | Unused | 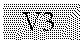 | V3 | 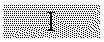 | — | 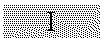 | — |
| 2 | Unused | 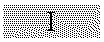 | — | 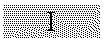 | — | 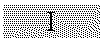 | — |
| 3 | Unused | 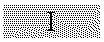 | — | 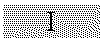 | — | 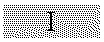 | — |
| 4 | Unused | 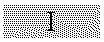 | — | 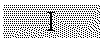 | — | 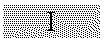 | — |
| 5 | Unused | 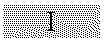 | — | 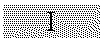 | — | 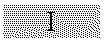 | — |
| 6 | Unused | 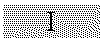 | — | 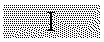 | — | 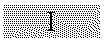 | — |
| 7 | Unused | 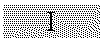 | — | 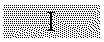 | — | 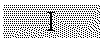 | — |
| 8 | Unused | 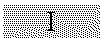 | — | 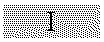 | — | 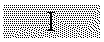 | — |
| 9 | Unused | 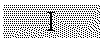 | — | 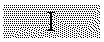 | — | 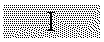 | — |
| 1 | Unused | 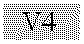 | V4 | 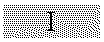 | — | 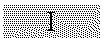 | — |
| 2 | Unused | 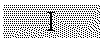 | — | 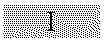 | — | 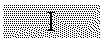 | — |
| 3 | Unused | 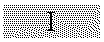 | — | 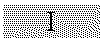 | — | 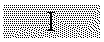 | — |
| 4 | Unused | 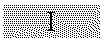 | — | 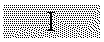 | — | 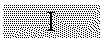 | — |
| 5 | Unused | 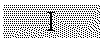 | — | 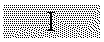 | — | 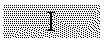 | — |
| 6 | Unused | 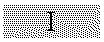 | — | 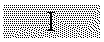 | — | 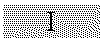 | — |
| 7 | Unused | 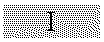 | — | 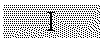 | — | 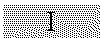 | — |
| 8 | Unused | 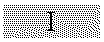 | — | 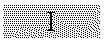 | — | 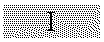 | — |
| 9 | Unused | 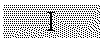 | — | 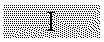 | — | 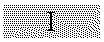 | — |

The first option is locked TVT mode, which carries the entire VT1.5/TU11 virtual tributary indicated by the shaded region in Table 18. The term “locked” is used to indicate that the location of the V1, V2 pointer is locked. The virtual tributary must have a valid V1, V2 pointer to locate the V5 payload. In this mode, the V5 indicator and payload signals, DV5, AV5, DPL and APL, may be generated but must be ignored by the receiving device. In locked TVT mode, timing is always sourced by the transmitting side, therefore, justification requests are not used and the justification request signal (AJUST_REQ) is ignored. Other than the V1 and V2 octets, which must carry valid pointers, all octets can carry data in any format. The location of the V1, V2, V3 and V4 octets is fixed to the locations shown in Table 18.

The second option is floating TVT mode, which carries the payload comprised of the V5 and I octets within the shaded region of Table 18. In this mode, the V1, V2 pointers are still in a fixed location and may be valid but are ignored by the receiving device. The V5 indicator and payload signals, DV5, AV5, DPL and APL, must be valid and are used to locate the floating payload. The justification request signal (AJUST_REQ) can be used to control the timing on the ADD BUS. The V3 octets are used to accommodate justification requests. The location of the V1, V2, V3 and V4 octets is fixed to the locations shown in Table 18.

Transparent VT2/TU12 Mapping

VT2 and TU12 virtual tributaries, also referred to as TVT2, are transported across the SBI bus in a similar manner to the E1 tributary mapping. Table 19 shows the transparent structure where “I” is used to indicate information bytes. As with TVT1.5 mapping, there are two options when carrying virtual tributaries on the SBI bus, locked TVT mode and floating TVT mode, the primary difference being how the floating V5 payload is located.

The TVT2 mapping in locked TVT mode and in floating TVT mode is the same as the TVT1.5 mapping discussed previously, with the V1, V2, V3, V4 and V5 octets located as shown in Table 19.

TABLE 19
Transparent VT2/TU12 Format

| | | E1# | #2,1- | E1# | #2,1- | E1# | #2,1- | E1# | #2,1- |
|---|---|---|---|---|---|---|---|---|---|
| | COL # | 1,1 | 3,21 | 1,1 | 3,21 | 1,1 | 3,21 | 1,1 | 3,21 |
| ROW # | 1-18 | 19 | 20-81 | 82 | 83-144 | 145 | 146-207 | 208 | 209-270 |
| 1 | Unused | V1 | V1 | V5 | — | I | — | I | — |
| 2 | Unused | I | — | I | — | I | — | I | — |
| 3 | Unused | I | — | I | — | I | — | I | — |
| 4 | Unused | I | — | I | — | I | — | I | — |
| 5 | Unused | I | — | I | — | I | — | I | — |
| 6 | Unused | I | — | I | — | I | — | I | — |
| 7 | Unused | I | — | I | — | I | — | I | — |
| 8 | Unused | I | — | I | — | I | — | I | — |
| 9 | Unused | I | — | I | — | I | — | I | — |
| 1 | Unused | V2 | V2 | I | — | I | — | I | — |
| 2 | Unused | I | — | I | — | I | — | I | — |
| 3 | Unused | I | — | I | — | I | — | I | — |
| 4 | Unused | I | — | I | — | I | — | I | — |
| 5 | Unused | I | — | I | — | I | — | I | — |
| 6 | Unused | I | — | I | — | I | — | I | — |
| 7 | Unused | I | — | I | — | I | — | I | — |
| 8 | Unused | I | — | I | — | I | — | I | — |
| 9 | Unused | I | — | I | — | I | — | I | — |
| 1 | Unused | V3 | V3 | I | — | I | — | I | — |
| 2 | Unused | I | — | I | — | I | — | I | — |
| 3 | Unused | I | — | I | — | I | — | I | — |
| 4 | Unused | I | — | I | — | I | — | I | — |
| 5 | Unused | I | — | I | — | I | — | I | — |
| 6 | Unused | I | — | I | — | I | — | I | — |
| 7 | Unused | I | — | I | — | I | — | I | — |
| 8 | Unused | I | — | I | — | I | — | I | — |
| 9 | Unused | I | — | I | — | I | — | I | — |
| 1 | Unused | V4 | V4 | I | — | I | — | I | — |
| 2 | Unused | I | — | I | — | I | — | I | — |
| 3 | Unused | I | — | I | — | I | — | I | — |
| 4 | Unused | I | — | I | — | I | — | I | — |
| 5 | Unused | I | — | I | — | I | — | I | — |
| 6 | Unused | I | — | I | — | I | — | I | — |
| 7 | Unused | I | — | I | — | I | — | I | — |
| 8 | Unused | I | — | I | — | I | — | I | — |
| 9 | Unused | I | — | I | — | I | — | I | — |

Fractional Rate Tributary Mapping

The Fractional Rate SBI mapping is intended for support of data services over Fractional DS3 or similar links. A Fractional rate link is mapped into any SPE octet as defined in Table 6. Table 20 shows all the available information (I) octets useable for carrying a Fractional rate link mapped to a single SPE. There are no V1 to V5 bytes or frame alignment signals in a Fractional rate link. The ADD BUS and DROP BUS payload signals, APL and DPL, indicate when a Fractional rate information byte contains valid data or is empty. The Fractional rate link ADD BUS can have the timing master be either the PHY or the Link Layer device. When the PHY is the timing master the justification request (AJUST_REQ) signal from the PHY communicates the transmit rate to the Link Layer device. The AJUST₁₃ REQ signal is asserted during any of the available Fractional rate link octets to indicate that the PHY can accept another byte of data. For every byte that is marked with the AJUST_REQ signal the Link Layer device should respond with a valid byte to the PHY within a short time. The PHY accepts data from the Link Layer device whenever it sees valid data as indicated by the ADD BUS Payload (APL) signal, whether it is timing master or slave.

TABLE 20
Fractional Rate Format

| | SPE | | | |
|---|---|---|---|---|
| | COL # | Fractional | Fractional | Fractional |
| | SBI COL # | 1 | 2-84 | Col 85 |
| ROW | 1, 4, 7, 10, 13 | 16 | . . . | 268 |
| 1 | Unused | I | I | I |
| 2 | Unused | I | I | I |
| 3 | Unused | I | I | I |
| 4 | Unused | I | I | I |
| 5 | Unused | I | I | I |
| 6 | Unused | I | I | I |
| 7 | Unused | I | I | I |
| 8 | Unused | I | I | I |
| 9 | Unused | I | I | I |

Drop Bus Interface Description

The DROP BUS is a byte wide serial bus, which drops SBI tributaries from multiple PHY devices to multiple link layer devices.

DROP BUS Signals

| Pin Name | Direction | Function |
|---|---|---|
| REFCLK | Input | Reference Clock (REFCLK). This signal |
| | | is an externally generated 19.44 MHz +/− |
| | | 50 ppm clock with a nominal 50% duty |
| | | cycle. Since the ADD and DROP buses are |
| | | locked together this clock is common to |
| | | both the ADD and DROP sides of the PHY- |
| | | LINK. |
| C1FP | Input | C1 Frame Pulse (C1FP). This signal is |
| | | single sourced to indicate the first C1 |
| | | octet on the PHY-LINK. Since the ADD |
| | | and DROP buses are locked together this |
| | | signal is common to both the ADD and |
| | | DROP sides of the PHY-LINK. |
| | | This frame pulse indicator is a single |
| | | REFCLK cycle long and is updated on the |
| | | rising edge of REFCLK. All devices |
| | | should sample this signal on the rising |
| | | edge of REFCLK. This signal also |
| | | indicates multiframe alignment which |
| | | occurs every 4 frames, therefore this |
| | | signal is pulsed every fourth C1 octet |
| | | to produce a 2 KHz multiframe signal. |
| | | The frame pulse does not need to be |
| | | repeated every 2 KHz therefore all |
| | | SBI devices should synchronize to |
| | | this signal but should also be able |
| | | to flywheel in its absence. When using |
| | | the SBI bus in synchronous mode the C1FP |
| | | signal can be used to indicate T1 and E1 |
| | | multiframe alignment by pulsing on 48 SBI |
| | | frame boundaries. |
| DDATA | PHY | DROP BUS Data (DDATA [7:0]). The |
| [7:0] | tristate | DROP data bus is a time division multi- |
| | output | plexed bus which transports tributaries by |
| | Link Layer | assigning them to fixed octets within |
| | input | the PHY-LINK structure. Multiple PHY |
| | | devices can drive this bus at uniquely |
| | | assigned tributary columns within the PHY- |
| | | LINK structure. DDATA [7:0] is asserted |
| | | and sampled on the rising edge of REFCLK. |
| DDP | PHY | DROP BUS Data Parity (DDP). This signal |
| | tristate | carries the even or odd parity for the |
| | output | DROP BUS signals. The parity calcula- |
| | Link Layer | tion encompasses the DDATA [7:0], DPL |
| | input | and DV5 signals. Multiple PHY devices can |
| | | drive this signal at uniquely assigned |
| | | tributary columns within the PHY-LINK |
| | | structure. This parity signal is intended to |
| | | detect multiple sources in the column |
| | | assignment. See Note 2 on Pin Descrip- |
| | | tions. DDP is asserted and sampled on the |
| | | rising edge of REFCLK. |
| DPL | PHY | DROP BUS Payload (DPL). This active |
| | tristate | high signal indicates valid data within |
| | output | the PHY-LINK structure. This signal is |
| | Link Layer | high during all octets making up a |
| | input | tributary which includes all octets |
| | | shaded grey in the framing format |
| | | tables. This signal goes high during |
| | | the V3 or H3 octet within a tributary |
| | | to accommodate negative timing |
| | | adjustments between the tributary rate |
| | | and the fixed PHY-LINK structure. This |
| | | signal goes low during the octet |
| | | following the V3 or H3 octet within a |
| | | tributary to accommodate positive |
| | | timing adjustments between the |
| | | tributary rate and the fixed PHY-LINK |
| | | structure. For Fractional rate links |
| | | this signal indicates that the current |
| | | octet is carrying valid data when high. |
| | | Multiple PHY devices can drive this |
| | | signal at uniquely assigned tributary |
| | | columns within the PHY-LINK structure. |
| | | In locked TVT mode this signal may be |
| | | driven but is ignored by the receiving |
| | | device. DPL is asserted and sampled on the |
| | | rising edge of REFCLK. |
| DV5 | PHY | DROP BUS Payload Indicator (DV5). This |
| | tristate | active high signal locates the position |
| | output | of the floating payloads for each |
| | Link Layer | tributary within the PHY-LINK |
| | input | structure. Timing differences between |
| | | the port timing and the PHY-LINK timing |
| | | are indicated by adjustments of this |
| | | payload indicator relative to the fixed |
| | | PHY-LINK structure. Multiple PHY devices |
| | | can drive this signal at uniquely assigned |
| | | tributary columns within the PHY-LINK |
| | | structure. All movements indicated by this |
| | | signal must be accompanied by appropriate |
| | | adjustments in the DPL signal. In locked |
| | | TVT mode or Fractional rate link mode |
| | | this signal may be driven but must be |
| | | ignored by the receiving device. DV5 |
| | | is asserted and sampled on the rising |
| | | edge of REFCLK. |
| DACTIVE | PHY Output | DROP BUS Active Indicator (DACTIVE). |
| | | This active high signal is asserted |
| | | high during all octets when driving |
| | | data and control signals, DDATA [7:0], |
| | | DDP, DPL and DV5, onto the bus. |
| | | All other SBI PHY devices driving the |
| | | bus listen to this signal on DDETECT to |
| | | detect multiple sources driving the bus |
| | | which can occur due to configuration |
| | | problems. DEACTIVE is asserted on the |
| | | rising edge of REFCLK. |
| DDETECT | PHY Input | DROP BUS Active Detector (DDETECT). |
| | | This input listens to the OR of all |
| | | other SBI DROP BUS masters. A PHY |
| | | device will listen to the OR of all |
| | | other PHY device DACTIVE signals. |
| | | When a device is driving DACTIVE high |
| | | and detects DDETECT is high from |
| | | another device, it signals a collision |
| | | and backs off driving the bus to |
| | | minimize or eliminate contention. |
| | | Some SBI devices may provide multiple |
| | | DDETECT signals which are internally |
| | | ORed together. DDETECT is an |
| | | asynchronous signal which must be used |
| | | to disable the tristate drivers on the DROP |
| | | bus. The AND of DACTIVE and DDETECT |
| | | is sampled on the rising edge of REFCLK to |
| | | indicate that a collision occurred and can be |
| | | used to indicate contention to management |
| | | procedures. See Note 2 on Pin Descriptions. |

Notes on Pin Descriptions

1. All outputs on the PHY-LINK are tristate outputs. Output drive is recommended 8 mA to handle capacitive loads up to 100 pF with 10 K Ohms connecting to 3.3V.

2. It is recommended that parity errors and bus collisions result in an interrupt so that software configuration problems or board level problems can be corrected or debugged. These interrupts should include an indication of which tributary caused the error.

3. All outputs should be tri-stated during and after a reset.

DROP BUS Functional Timing

FIG. 3 shows the DROP BUS timing for a T1/E1 tributary. There is a negative justification on the V3 octet 32. This is indicated by asserting DPL high during the V3 octet 32. FIG. 3 also shows the location of one of the tributaries by asserting DV5 high during the V5 octet 35. The DACTIVE signal indicates an SBI PHY device which is sourcing all tributaries in the first SPE. DACTIVE is not asserted high during the unused columns of all tributary mappings.

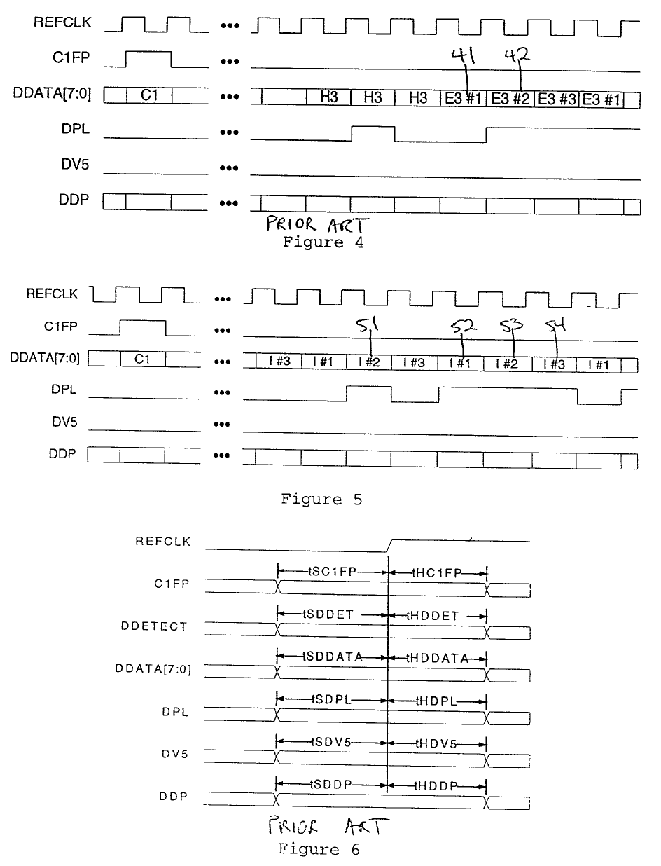

FIG. 4 is a timing diagram where three E3 tributaries are mapped onto an SBI bus. A negative justification is shown for E3#2 during the H3 octet with DPL asserted high. A positive justification is shown for E3#1 during the first E3#1 octet 41 after H3 which has DPL asserted low.

FIG. 5 is a timing diagram where three Fractional rate links are mapped onto an SBI bus, one in each SPE. The Payload signal, DPL, indicates valid data during the bytes 51, 52, 53, 54 where it is high. In FIG. 5 all available bytes in Fractional rate link #2 are filled while only one byte in Fractional rate link #1 and #3 are filled. DV5 is not used with Fractional rate links.

DROP BUS Interface Timing Characteristics

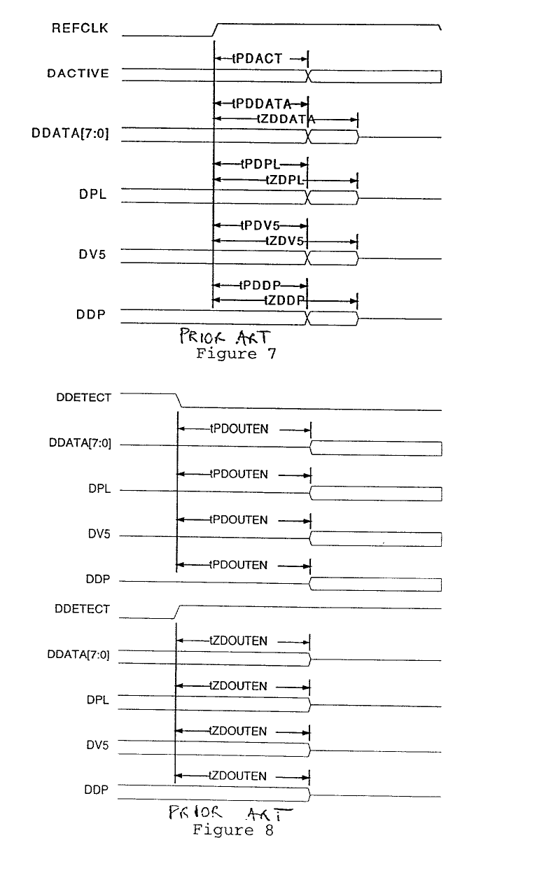

FIG. 6 shows the DROP BUS interface input timing diagram, with the values for the timing parameters listed in Table 21. FIG. 7 shows the DROP BUS interface output timing diagram, with the values for the timing parameters listed in Table 22. FIG. 8 shows the DROP BUS asynchronous interface output timing diagram, with the values for the timing parameters listed in Table 23.

(TC=−40° C. to +85° C., VDD=3.3V±10%)

TABLE 21
DROP BUS Interface Input Timing

| Symbol | Parameter | Min | Max | Units |
|---|---|---|---|---|
| tSC1FP | REFCLK to Valid C1FP Set-up Time | 4 | | ns |
| tHC1FP | REFCLK to Valid C1FP Hold Time | 0 | | ns |
| tSDDET | REFCLK to Valid DDETECT Set-up | 20 | | ns |
| | Time | | | |
| tHDDET | REFCLK to Valid DDETECT Hold | 0 | | ns |
| | Time | | | |
| tSDDATA | REFCLK to Valid DDATA Set-up | 4 | | ns |
| | Time | | | |
| tHDDATA | REFCLK to Valid DDATA Hold | 0 | | ns |
| | Time | | | |
| tSDPL | REFCLK to Valid DPL Set-up Time | 4 | | ns |
| tHDPL | REFCLK to Valid DPL Hold Time | 0 | | ns |
| tSDV5 | REFCLK to Valid DV5 Set-up Time | 4 | | ns |
| tHDV5 | REFCLK to Valid DV5 Hold Time | 0 | | ns |
| tSDDP | REFCLK to Valid DDP Set-up Time | 4 | | ns |
| tHDDP | REFCLK to Valid DDP Hold Time | 0 | | ns |

TABLE 22
DROP BUS Interface Output Timing

| Symbol | Parameter | Min | Max | Units |
|---|---|---|---|---|
| tPDACT | REFCLK Edge to DACT Prop Delay | 2 | 15 | ns |
| tPDDATA | REFCLK Edge to DDATA Prop Delay | 2 | 20 | ns |
| | (consecutive tributary assignment) | | | |
| tZDDATA | REFCLK Edge to DDATA Output Tri- | 2 | 20 | ns |
| | state (non-consecutive tributary | | | |
| | assignment) | | | |
| tPDPL | REFCLK Edge to DPL Prop Delay | 2 | 20 | ns |
| | (consecutive tributary assignment) | | | |
| tZDPL | REFCLK Edge to DPL Output Tri-state | 2 | 20 | ns |
| | (non-consecutive tributary assignment) | | | |
| tPDV5 | REFCLK Edge to DV5 Prop Delay | 2 | 20 | ns |
| | (consecutive tributary assignment) | | | |
| tZDV5 | REFCLK Edge to DV5 Output Tri-state | 2 | 20 | ns |
| | (non-consecutive tributary assignment) | | | |
| tPDDP | REFCLK Edge to DDP Prop Delay | 2 | 20 | ns |
| | (consecutive tributary assignment) | | | |
| tZDDP | REFCLK Edge to DDP Output Tri-state | 2 | 20 | ns |
| | (non-consecutive tributary assignment) | | | |

TABLE 23
DROP BUS Asynchronous Interface Output Timing

| Symbol | Parameter | Min | Max | Units |
|---|---|---|---|---|
| tPDOUTEN | Asynchronous DDETECT Low to | | 12 | ns |
| | DDATA [7:0], DPL, DV5, DDP Prop | | | |
| | Delay | | | |
| tZDOUTEN | Asynchronous DDETECT High to | | 12 | ns |
| | DDATA [7:0], DPL, DV5, DDP | | | |
| | High Impedance | | | |

ADD BUS Interface Description

The ADD BUS is a byte wide serial bus, which aggregates tributaries from multiple Link Layer devices to multiple PHY devices. Some signals within the ADD BUS are also driven by the PHY devices in order to communicate transmit timing from the PHY devices to the Link Layer devices on a per tributary basis.

ADD BUS Signals

| Pin Name | Direction | Function |
|---|---|---|
| REFCLK | Input | Reference Clock (REFCLK). See |
| | | Description in DROP BUS Interface |
| | | Description section. This signal is |
| | | common to both buses. |
| C1FP | Input | C1 Frame Pulse (C1FP). See Description |
| | | in DROP BUS Interface Description section. |
| | | This signal is common to both buses. |
| ADATA | Link Layer | ADD Data (ADATA [7:0]). The ADD data |
| [7:0] | tristate | bus is a time division multiplexed bus which |
| | output | transports tributaries by assigning them |
| | PHY input | to fixed octets within the PHY-LINK |
| | | structure. This bus has multiple sources |
| | | which are each assigned unique fixed octets |
| | | within the PHY-LINK structure. DDATA |
| | | [7:0] is asserted and sampled on |
| | | the rising edge of REFCLK. |
| ADP | Link Layer | ADD BUS Data Parity (ADP). This signal |
| | tristate | carries the even or odd parity for the |
| | output | ADD BUS signals. The parity calculation |
| | PHY input | encompasses ADATA [7:0], APL and AV5 |
| | | signals. Multiple Link Layer devices can |
| | | drive this signal at uniquely assigned |
| | | tributary columns within the PHY-LINK |
| | | structure. This parity signal is |
| | | intended to detect conflicts in the |
| | | tributary assignment. See Note 2 on Pin |
| | | Descriptions. ADP is asserted and sampled |
| | | on the rising edge of REFCLK. |
| APL | Link Layer | ADD BUS Payload (APL). This signal |
| | tristate | indicates valid data within the PHY-LINK |
| | output | structure. This active high signal is |
| | PHY input | asserted during all octets making up a |
| | | tributary. This signal goes high during |
| | | the V3 or H3 octet within a tributary to |
| | | accommodate negative timing adjustments |
| | | between the tributary rate and the fixed |
| | | PHY-LINK structure. This signal goes low |
| | | during the octet after the V3 or H3 |
| | | octet within a tributary to accommodate |
| | | positive timing adjustments between the |
| | | tributary rate and the fixed PHY-LINK |
| | | structure. For Fractional rate links |
| | | this signal indicates that the current |
| | | octet is carrying valid data when high. |
| | | Multiple Link Layer devices can drive |
| | | this signal at uniquely assigned |
| | | tributary columns within the PHY-LINK |
| | | structure. In locked TVT mode this signal |
| | | may be driven but must be ignored by the |
| | | receiving device. APL is asserted and |
| | | sampled on the rising edge of REFCLK. |
| AV5 | Link Layer | ADD BUS Payload Indicator (AV5). This |
| | tristate | active low signal locates the position |
| | output | of the floating payload for each |
| | PHY input | tributary within the ADD BUS structure. |
| | | Multiple Link Layer devices can drive |
| | | this signal at uniquely assigned |
| | | tributary columns within the PHY-LINK |
| | | structure. All movements indicated by |
| | | this signal must be accompanied by |
| | | appropriate adjustments in the APL |
| | | signal. In locked TVT mode or Fractional |
| | | rate link mode this signal may be driven but |
| | | must be ignored by the receiving device. |
| | | AV5 is asserted and sampled on the |
| | | rising edge of REFCLK. |
| AJUST_{—} | PHY | ADD BUS Justification Request (ADJUST_{—} |
| REQ | tristate | REQ). This signal is used to speed up, |
| | output | slow down or maintain the minimal |
| | Link Layer | rate of the Link Layer device |
| | input | which is sending data to the PHY. This |
| | | is only used when the PHY layer device |
| | | is the timing master for the transmit |
| | | direction. This active high signal indicates |
| | | negative timing adjustments when |
| | | asserted high during the V3 or H3 octet. |
| | | In response to this the Link Layer |
| | | device should send an extra byte in the |
| | | V3 or H3 octet of the next frame along |
| | | with valid DPL indicating a negative |
| | | justification. This signal indicates positive |
| | | timing adjustments when asserted high |
| | | during the octet following the V3 or H3 |
| | | octet. The Link Layer device should respond |
| | | to this by not sending an octet during the |
| | | octet following the V3 or H3 octet of |
| | | the next frame along with valid DPL |
| | | indicating a positive justification. |
| | | For Fractional rate links this signal is |
| | | asserted high during any available |
| | | information byte to indicate to the Link |
| | | Layer device that the PHY is able to |
| | | accept another byte of data. For every |
| | | byte that this signal is asserted high |
| | | the Link Layer device is expected to |
| | | send a valid byte of data. All timing |
| | | adjustments from the Link Layer in |
| | | response to the justification request |
| | | must still set the payload and payload |
| | | indicators appropriately for timing adjust- |
| | | ments. In synchronous T1 and E1 modes this |
| | | signal is unused and must be held high. |
| | | In locked TVT mode this signal is unused |
| | | and must be held high. AJUST_REQ is |
| | | asserted and sampled on the rising edge of |
| | | REFCLK. |
| AACTIVE | Link Layer | ADD BUS Active Indicator (AACTIVE). |
| | Output | This active high signal is asserted high |
| | | during all octets when driving data and |
| | | control signals, ADATA [7:0], ADP, APL |
| | | and AV5, onto the bus. All other SBI Link |
| | | Layer devices driving the bus listen to this |
| | | signal to detect multiple sources driving the |
| | | bus which can occur due to configuration |
| | | problems AACTIVE is asserted on the rising |
| | | edge of REFCLK. |
| ADETECT | Link Layer | ADD BUS Active Detector (ADETECT). |
| | Input | This input listens to the OR of all other |
| | | SBI Link Layer bus masters. A Link Layer |
| | | device will listen to the OR of all |
| | | other Link Layer AACTIVE signals. |
| | | When a device is driving AACTIVE high |
| | | and detects ADETECT is high from another |
| | | device it signals a collision and backs |
| | | off driving the bus to minimize or |
| | | eliminate contention. Some SBI devices |
| | | may provide multiple ADETECT signals |
| | | which are internally ORed together. |
| | | ADETECT is an asynchronous signal which |
| | | must be used to disable the tristate |
| | | drivers on the ADD bus. The AND of |
| | | AACTTVE and ADETECT is sampled on |
| | | the rising edge of REFCLK to indicate that a |
| | | collision occurred and can be used to |
| | | indicate contention to management |
| | | procedures. See Note 2 on Pin Descriptions. |

Notes on Pin Descriptions

1. All outputs on the PHY-LINK are tristate outputs. Output drive is recommended 8 mA to handle capacitive loads up to 100 pF with 10K Ohms connecting to 3.3V.

2. It is recommended that parity errors and bus collisions result in an interrupt so that software configuration problems or board level problems can be corrected or debugged. These interrupts should include an indication of which tributary caused the error.

3. All outputs should be tri-stated during and after a reset.

ADD BUS Functional Timing

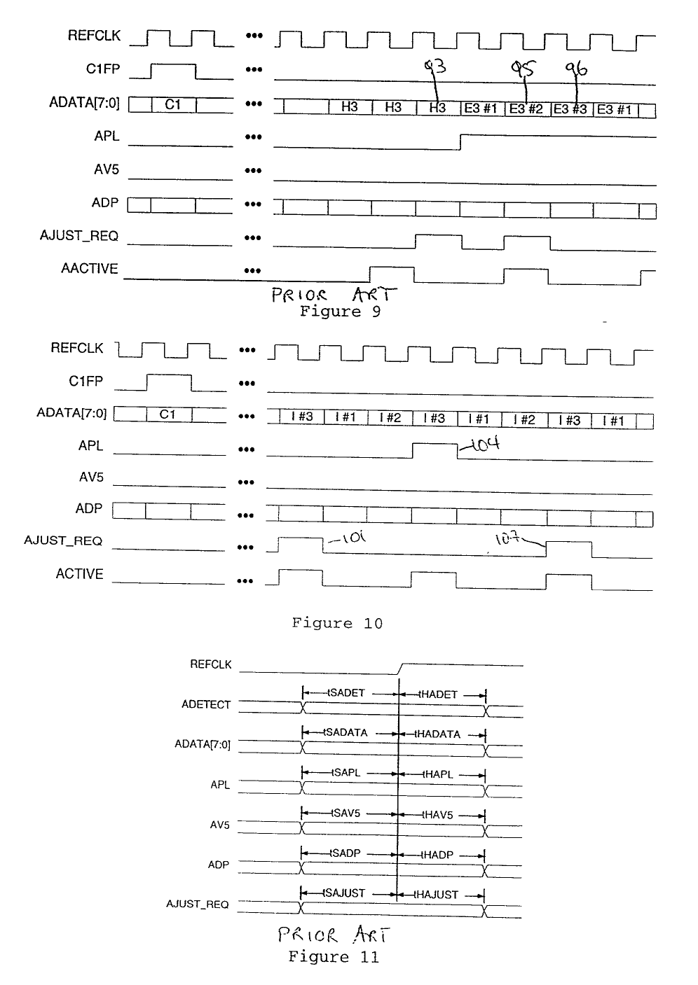

FIG. 9 shows the DS3/E3 tributary functional timing pattern. There are both positive and negative justification requests, which would take effect during the next multi-frame. The negative justification request occurs on the E3#3 tributary 96 when AJUST_REQ is asserted high during the H3 octet 93. The positive justification occurs on the E3#2 tributary when AJUST₁₃ REQ is asserted high during the first E3#2 octet 95 after the H3 octet 93. The AACTIVE signal indicates an SBI Link Layer device which is driving E3#2 onto the SBI ADD BUS.

FIG. 10 shows the functional timing of a single Fractional rate link mapped to SPE#3. The AJUST₁₃ REQ signal is asserted high twice 101, 107 during SPE#3 to indicate that the Link Layer device timing slave can send two bytes of data. The APL signal asserted high 104 indicates a valid byte of data on the ADD BUS in response to the first AJUST_REQ signal or to an earlier AJUST_REQ pulse.

ADD BUS Interface Timing Characteristics

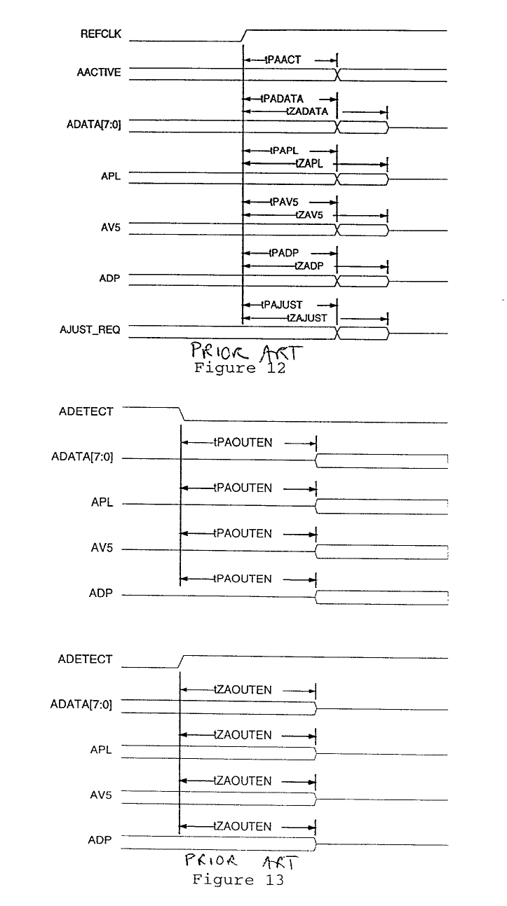

FIG. 11 shows the ADD BUS interface input timing diagram. The values of the input timing parameters are listed in Table 24. FIG. 12 shows the ADD BUS interface output timing diagram. The values of the output timing parameters are listed in Table 25. FIG. 13 shows the ADD BUS asynchronous interface output timing diagram. The values of the asynchronous output timing parameters are listed in Table 26.

(TC=−40° C. to +85° C., VDD=3.3V±10%)

TABLE 24
ADD BUS Interface Input Timing

| Symbol | Parameter | Min | Max | Units |
|---|---|---|---|---|
| tSADET | REFCLK to Valid ADETECT Set-up | 20 | | ns |
| | Time | | | |
| tHADET | REFCLK to Valid ADETECT Hold | 0 | | ns |
| | Time | | | |
| tSADATA | REPCLK to Valid ADATA Set-up | 4 | | ns |
| | Time | | | |
| tHADATA | REFCLK to Valid ADATA Hold | 0 | | ns |
| | Time | | | |
| tSAPL | REFCLK to Valid APL Set-up | 4 | | ns |
| | Time | | | |
| tHAPL | REFCLK to Valid APL Hold Time | 0 | | ns |
| tSAV5 | REFCLK to Valid AV5 Set-up Time | 4 | | ns |
| tHAV5 | REFCLK to Valid AV5 Hold Time | 0 | | ns |
| tSADP | REFCLK to Valid ADP Set-up Time | 4 | | ns |
| tHADP | REFCLK to Valid ADP Hold Time | 0 | | ns |
| tSAJUST | REFCLK to Valid AJUST_REQ | 4 | | ns |
| | Set-up Time | | | |
| tHAJUST | REFCLK to Valid AJUST_REQ | 0 | | ns |
| | Hold Time | | | |

TABLE 25
ADD BUS Interface Output Timing

| Symbol | Parameter | Min | Max | Units |
|---|---|---|---|---|
| tPAACT | REFCLK Edge to AACT Prop | 2 | 15 | ns |
| | Delay | | | |
| tPADATA | REFCLK Edge to ADATA Prop | 2 | 20 | ns |
| | Delay (consecutive tributary | | | |
| | assignment) | | | |
| tZADATA | REFCLK Edge to ADATA Output | 2 | 20 | ns |
| | Tri-state (non-consecutive tributary | | | |
| | assignment) | | | |
| tPAPL | REFCLK Edge to APL Prop Delay | 2 | 20 | ns |
| | (consecutive tributary assignment) | | | |
| tZAPL | REFCLK Edge to APL Output Tri- | 2 | 20 | ns |
| | state (non-consecutive tributary | | | |
| | assignment) | | | |
| tPAV5 | REFCLK Edge to AV5 Prop Delay | 2 | 20 | ns |
| | (consecutive tributary assignment) | | | |
| tZAV5 | REFCLK Edge to AV5 Output Tri- | 2 | 20 | ns |
| | state (non-consecutive tributary | | | |
| | assignment) | | | |
| tPADP | REFCLK Edge to ADP Prop Delay | 2 | 20 | ns |
| | (consecutive tributary assignment) | | | |
| tZADP | REFCLK Edge to ADP Output Tri- | 2 | 20 | ns |
| | state (non-consecutive tributary | | | |
| | assignment) | | | |
| tPAJUST | REFCLK Edge to AJUST_REQ | 2 | 20 | ns |
| | Prop Delay (consecutive tributary | | | |
| | assignment) | | | |
| tZAJUST | REFCLK Edge to AJUST_{—} | 2 | 20 | ns |
| | REQ Output Tri-state (non- | | | |
| | consecutive tributary assignment) | | | |

TABLE 26
ADD BUS Asynchronous Interface Output Timing

| Symbol | Parameter | Min | Max | Units |
|---|---|---|---|---|
| tPAOUTEN | Asynchronous ADETECT Low to | | 12 | ns |
| | ADATA [7:0], APL, AV5, ADP Prop | | | |
| | Delay | | | |
| tZAOUTEN | Asynchronous ADETECT High to | | 12 | ns |
| | ADATA [7:0], APL, AV5, ADP | | | |
| | High Impedance | | | |

The 77.76 MHz SBI336 Bus

The 77.76 MHz SBI bus, referred to as SBI336, is similar to four interleaved 19.44 MHz SBI buses. There are some slight differences between the two formats to accommodate the increased clock rate. The changes are:

1) Tighter timing characteristics for support of a 77.76 MHz multiplexed bus.

2) Fewer loads are supported on the SBI336 bus to help with timing of the multiplexed bus. Bus loading is reduced to 50 pF, restricted to five devices per signal with several inches of wire between the devices. The SBI336 bus is not supported over backplanes.

3) Independent C1FP pulses for the ADD direction, AC1FP, and the DROP direction, DC1FP.

4) The AJUST_REQ signal is referenced to the DROP BUS DC1FP alignment rather than the common ADD/DROP C1FP alignment of the SBI bus. This aids 77.76 MHz bus timing by allowing buffering and retiming logic to be put between SBI336 devices. This change also aids construction of larger SBI cross connect systems using smaller buffers between devices by controlling the C1 frame alignment independently in each direction.

5) The bus contention detection logic and the capability of bus contention detection to tri-state the output drivers have been removed. The ACTIVE and DETECT signals in Tables 21 to 26 and FIGS. 3 and 6 to 13 are not used in the SBI336 bus timing.

SBI336 Multiplexing Structure

TABLE 27
Structure for Carrying Multiplexed Links in SBI336

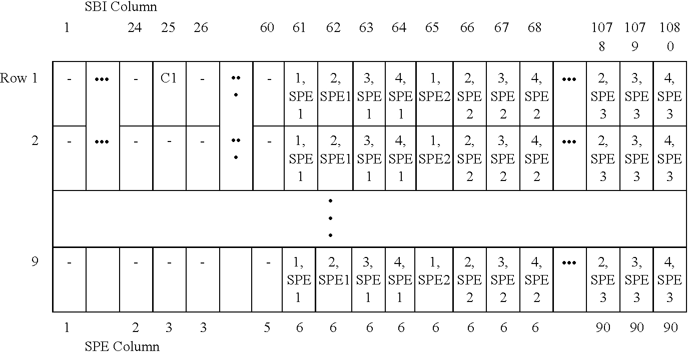

Table 27 shows how 12 SPEs are multiplexed into a 77.76 MHz SBI336 bus. The structure is the same as byte interleaving four 19.44 MHz SBI buses. “1, SPE1” identifies SPE1 from the first SBI equivalent bus, “2,SPE1” identifies SPE1 from the second SBI equivalent bus, and so on. All tributary mapping formats are the same as for the 19.44 MHz SBI bus with the only difference being that there are four times the number of tributaries. Tributary numbering appends the equivalent SBI number to the original SBI numbering. For example, the first T1 in a SBI bus would be numbered T1#1,1 whereas the first T1 in a SBI336 bus would be numbered T1#1,1,1. Likewise, the second T1 in a SBI bus would be T1#2,1 whereas the second T1 in a SBI336 bus would be T1#2,1,1.

SBI336 DROP BUS Interface Timing

The SBI336 DROP BUS interface timing diagrams are similar to the SBI DROP BUS interface timing diagrams shown in FIGS. 6 and 7. The SBI336 DROP BUS interface timing parameter values are listed in Table 28 and 29. The SBI asynchronous timing diagrams of FIG. 8 are not applicable to the SBI336 bus. There are separate C1FP signals for the ADD and DROP buses so this timing is specified for both the DROP BUS signal DC1FP and the ADD BUS signal AC1FP. SBI336 bus contention detection has been removed, therefore, the tSDDET, tHDDET and tPDACT signals do not exist and the timing parameters are not applicable.

(TC=−40° C. to +85° C., VDD=3.3V±10%)

TABLE 28
SBI336 DROP BUS Input Timing

| Symbol | Parameter | Min | Max | Units |
|---|---|---|---|---|
| tSC1FP | REFCLK to Valid DC1FP and | 3 | | ns |
| | AC1FP Set-up Time (See Note 1) | | | |
| tHC1FP | REFCLK to Valid DC1FP and | 0 | | ns |
| | AC1FP Hold Time | | | |
| tSDDET | REFCLK to Valid DDETECT Set- | N/A | | ns |
| | up Time | | | |
| tHDDET | REFCLK to Valid DDETECT | N/A | | ns |
| | Hold Time | | | |
| tSDDATA | REFCLK to Valid DDATA Set- | 3 | | ns |
| | up Time | | | |
| tHDDATA | REFCLK to Valid DDATA Hold | 0 | | ns |
| | Time | | | |
| tSDPL | REFCLK to Valid DPL Set-up | 3 | | ns |
| | Time | | | |
| tHDPL | REFCLK to Valid DPL Hold Time | 0 | | ns |
| tSDV5 | REFCLK to Valid DV5 Set-up | 3 | | ns |
| | Time | | | |
| tHDV5 | REFCLK to Valid DV5 Hold Time | 0 | | ns |
| tSDDP | REFCLK to Valid DDP Set-up | 3 | | ns |
| | Time | | | |
| tHDDP | REFCLK to Valid DDP Hold Time | 0 | | ns |

TABLE 29
SBI336 DROP BUS Output Timing

| Symbol | Parameter | Min | Max | Units |
|---|---|---|---|---|
| tPDACT | REFCLK Edge to DACT Prop Delay | N/A | N/A | ns |
| tPDDATA | REFCLK Edge to DDATA Prop | 1 | 7 | ns |
| | Delay | | | |
| tZDDATA | REFCLK Edge to DDATA Output | 1 | 7 | ns |
| | Tri-state | | | |
| tPDPL | REFCLK Edge to DPL Prop Delay | 1 | 7 | ns |
| tZDPL | REFCLK Edge to DPL Output | 1 | 7 | ns |
| | Tri-state | | | |
| tPDV5 | REFCLK Edge to DV5 Prop Delay | 1 | 7 | ns |
| tZDV5 | REFCLK Edge to DV5 Output | 1 | 7 | ns |
| | Tri-state | | | |
| tPDDP | REFCLK Edge to DDP Prop Delay | 1 | 7 | ns |
| tZDDP | REPCLK Edge to DDP Output | 1 | 7 | ns |
| | Tri-state | | | |

SBI336 ADD BUS Interface Timing

The SBI336 ADD BUS interface timing diagrams are similar to the SBI ADD BUS interface timing diagrams shown in FIGS. 11 and 12. The SBI336 ADD BUS interface timing parameters are listed in Table 30 and 31. The SBI asynchronous timing diagrams of FIG. 13 are not applicable to the SBI336 bus. There are separate C1FP signals for the ADD and DROP buses so this timing is specified for both the DROP BUS signal DC1FP and the ADD BUS signal AC1FP. SBI336 bus contention detection has been removed, therefore, the tSADET, tHADET and tPAACT signals do not exist and the timing parameters are not applicable.

(TC=−40° C. to +85° C., VDD=3.3V±10%)

TABLE 30
SBI336 ADD BUS Input Timing (referenced to FIG. 11)

| Symbol | Parameter | Min | Max | Units |
|---|---|---|---|---|
| tSADET | REFCLK to Valid ADETECT Set-up | N/A | | ns |
| | Time (See Note 2) | | | |
| tHADET | REFCLK to Valid ADETECT Hold | N/A | | ns |
| | Time (See Note 2) | | | |
| tSADATA | REFCLK to Valid ADATA Set-up | 3 | | ns |
| | Time | | | |
| tHADATA | REFCLK to Valid ADATA Hold | 0 | | ns |
| | Time | | | |
| tSAPL | REFCLK to Valid APL Set-up Time | 3 | | ns |
| tHAPL | REFCLK to Valid APL Hold Time | 0 | | ns |
| tSAV5 | REFCLK to Valid AV5 Set-up Time | 3 | | ns |
| tHAV5 | REFCLK to Valid AV5 Hold Time | 0 | | ns |
| tSADP | REFCLK to Valid ADP Set-up Time | 3 | | ns |
| tHADP | REFCLK to Valid ADP Hold Time | 0 | | ns |
| tSAJUST | REFCLK to Valid AJUST_{—} | 3 | | ns |
| | REQ Set-up Time | | | |
| tHAJUST | REFCLK to Valid AJUST_{—} | 0 | | ns |
| | REQ Hold Time | | | |

TABLE 31
SBI336 ADD BUS Output Timing (referenced to FIG. 12)

| Symbol | Parameter | Min | Max | Units |
|---|---|---|---|---|
| tPAACT | REFCLK Edge to AACT Prop Delay | N/A | N/A | ns |
| | (See Note 2) | | | |
| tPADATA | REFCLK Edge to ADATA Prop Delay | 1 | 7 | ns |
| tZADATA | REFCLK Edge to ADATA Output Tri- | 1 | 7 | ns |
| | state | | | |
| tPAPL | REFCLK Edge to APL Prop Delay | 1 | 7 | ns |
| tZAPL | REFCLK Edge to APL Output Tri-state | 1 | 7 | ns |
| tPAV5 | REFCLK Edge to AV5 Prop Delay | 1 | 7 | ns |
| tZAV5 | REFCLK Edge to AV5 Output Tri-state | 1 | 7 | ns |
| tPADP | REFCLK Edge to ADP Prop Delay | 1 | 7 | ns |
| tZADP | REFCLK Edge to ADP Output Tri-state | 1 | 7 | ns |
| tPAJUST | REFCLK Edge to AJUST_REQ Prop | 1 | 7 | ns |
| | Delay (See Note 1) | | | |
| tZAJUST | REFCLK Edge to AJUST_REQ Output | 1 | 7 | ns |
| | Tri-state (See Note 1) | | | |

SBI336-SBI Compatibility

All links that can be transported over the 19.44 MHz SBI bus can be transported over the 77.76 Mhz SBI336 bus. It is also possible with straightforward glue logic to connect SBI and SBI336 buses.

The Linkrate octet which communicates individual clock rate information across the SBI and SBI336 bus is dependent on REFCLK. For the SBI bus the Linkrate octet carries clock rate and clock phase information that is measured with the 19.44 MHz SBI reference clock relative to the C1FP pulse. When in SBI336 mode the Linkrate clock rate and phase information is still measured relative to a 19.44 MHz reference clock and a C1FP pulse.

The same principle is used to generate Linkrate in the SBI336 bus as is done in the SBI bus (see Table 1 and Table 3). For SBI336 the same measurement is done with the 77.76 MHZ clock rather than generating a 19.44 MHz clock. The clock rate encoding and measurement is not changed because it is a count of T1/E1/DS3/E3 clocks between consecutive C1FP pulses, which is exactly the same period for SBI and SBI336. The phase measurement and encoding is done the same but uses the 77.76 MHz clock count from C1FP rather than a 19.44 MHz clock count. The Phase[3:0] field at 77.76 MHz could also be described as Phase[5:2] which reflects that the count is four times faster at 77.76 MHz but is also dropping off the two least significant bits.

For the SBI336 bus there are two different C1FP signals. For the purposes of generating the Linkrate octet and recreating the clock from the Linkrate octet, AC1FP is used as the reference on the ADD BUS and DC1FP is used as the reference on the DROP BUS.

The SBI336 bus has tighter timing than the SBI bus. When a device is compatible with both the SBI and SBI336 bus the following timing parameters must be used: minimum propagation delay from the SBI spec (2 ns), maximum propagation delay from SBI336 spec (7 ns), setup from SBI336 spec (3 ns) and hold from SBI336 spec (0 ns).

The SBI336S Bus

The SBI336S bus is a 777.6 MHz point-to-point LVDS interface that supports the same traffic types and capabilities as the SBI336 bus. 8B/10B coding is used on the serial link to enable data recovery and to provide codes to transmit additional SBI control information across the serial interface. Like the SBI336 bus, the SBI336S bus encodes ADD BUS clock master timing from the PHY device to the Link Layer device over the DROP BUS.

In addition to the capabilities of the SBI336 bus, the SBI336S bus provides an in-band communications channel between devices. This channel is intended for devices at one end of the link to communicate with devices at the other end of the link.

SBI336S-SBI Compatibility The 8B/10B encoded SBI336S stream operates in various modes of operation at a tributary level. Common to all tributaries is identification of the first C1 byte, which is equivalent to the AC1FP and DC1FP signals of the SBI336 format. There are unique mappings of the 8B/10B codes within the SBI336S format for the various link types: Asynchronous T1/E1, Synchronous (locked) T1/E1, Transparent VT1.5/VT2, DS3/E3 and Fractional links. Much of the identification and mapping/demapping of a link is based on the C1 frame pulse, C1 multiframe alignment and per tributary configuration knowledge. In addition to C1FP identification, the 8B/10B codes identify valid payload, pointer movements for floating tributaries and timing control.

There are some restrictions with the SBI336S bus compared with the SBI bus. The first restriction is that floating TVTs do not support slave mode timing on the ADD BUS. The impact of this is that a Link Layer device supporting TVTs will have to generate TVTs at its own internally generated rate and the PHY device will have to accept the TVT at that given rate and perform pointer justifications as required.

The second restriction is that slave mode timing on the ADD BUS for Fractional links must be near symmetric. With slave timed Fractional links the Link Layer device must use the DROP BUS rate, with minor corrections from the PHY device over the DROP BUS, as the master transmit rate. The PHY device will keep track of the rate of data on the DROP BUS relative to the required transmit rate and will make single byte per frame rate adjustment requests relative to the DROP BUS to the Link Layer device. The rate adjustment requests are sent on the DROP BUS during the H3 byte.

All Linkrate information is measured following the SBI336 specifications. This requires a common SBI-compatible reference clock be distributed to all SBI336S devices. The method of distributing this reference clock to all devices is outside the scope of this specification, however this can be accomplished with 8 KHz or 2 KHz reference pulses with localized PLLs.

SBI336S Alignment

The alignment functionality preformed by each SBI336S receiver can be broken down into two parts, character alignment and frame alignment. Character alignment finds the 8B/10B character boundary in the arbitrarily aligned incoming data. Frame alignment finds SBI336S frame and multiframe boundaries within the SBI336S link.

The character and frame alignment are expected to be robust enough for operation over a cabled interconnect.

Character Alignment Block

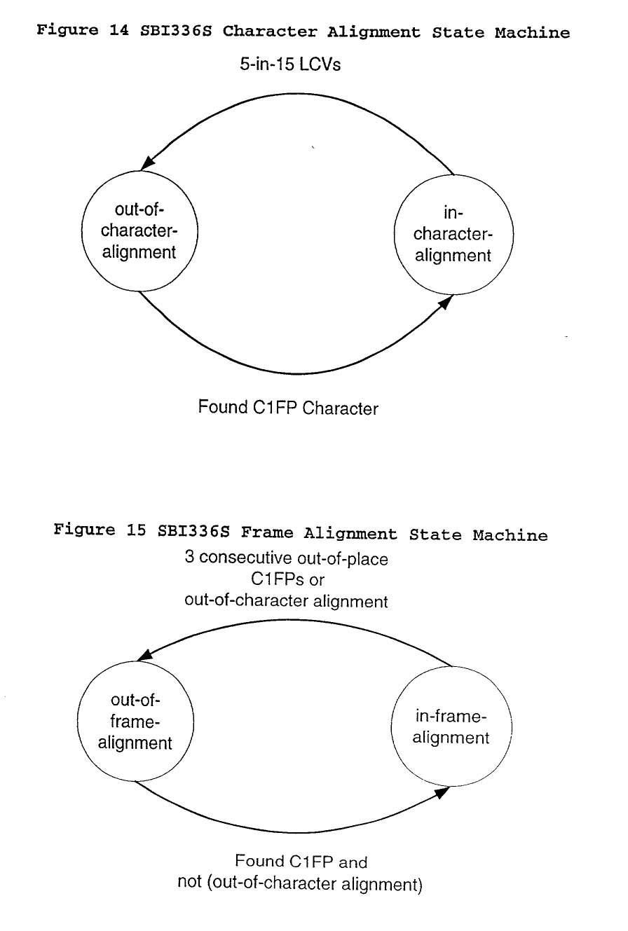

Character alignment locates character boundaries in the incoming 8B/10B data stream. The character alignment algorithm may be in one of two states, in-character-alignment state or out-of-character-alignment state. The two states of the character alignment algorithm are shown in FIG. 14.

When the character alignment state machine is in the out-of-character-alignment state, it maintains the current alignment, while searching for a C1FP character. If it finds the C1FP character it will re-align to the C1FP character and move to the in-character-alignment state. The C1FP character is found by searching for the 8B/10B C1FP character, K28.5+ or K28.5−, simultaneously in ten possible bit locations. While in the in-character-alignment state, the state machine monitors Line Code Violations (LCVs). If 5 or more LCVs are detected within a 15-character window the character alignment state machine transitions to out-of-character-alignment state. The SBI336S special characters listed in Table 32 are ignored for LCV purposes. Upon return to in-character-alignment state the LCV count is cleared.

Frame Alignment

SBI336S frame alignment locates SBI frame and multiframe boundaries in the incoming 8B/10B data stream. The frame alignment state machine may be in one of two states, in-frame-alignment state and out-of-frame-alignment state. Each SBI336S frame is 125 uS in duration. The two states of the frame alignment algorithm are shown in FIG. 15.

Encoded over the SBI336S frame alignment is SBI336S multiframe alignment, which is every four SBI336S frames or 500 uS. When carrying DS0 traffic in synchronous mode, signaling multiframe alignment is also necessary and is also encoded over SBI336S alignment. Signaling multiframe alignment is every 24 frames for T1 links and every 16 frames for E1 links, therefore signaling multiframe alignment covering both T1 and E1 multiframe alignment is every 48 SBI336S frames or 6 ms. Therefore C1FP characters are sent every four or every 48 frames respectively.

The frame alignment state machine establishes frame alignment over the link and is based on the SBI336S frame and not the SBI336S multiframe alignments. When the frame alignment state machine is in the out-of-frame-alignment state, it maintains the current alignment, while searching for a C1FP character. When it finds the C1FP character the state machine transitions to the in-frame-alignment state. While in the in-frame-alignment state the state machine monitors out-of-place C1FP characters. Out-of-place C1FP characters are identified by maintaining a frame counter based on the C1FP character. The SBI counter is initialized by the C1FP character when in the out-of-character-alignment state, and is unaffected in the in-character-alignment state. If 3 consecutive C1FPs have been found that do not agree with the expected location as defined by the frame counter, the state will change to out-of-frame-alignment state.

The frame alignment state machine is also sensitive to character alignment. When the character alignment state machine is in the out-of-character-alignment state, the frame alignment state machine is forced out-of-frame-alignment, and is held in that state until the character alignment state machine transitions to the in-character-alignment state.

Multiframe Alignment

SBI336S multiframe alignment is communicated across the link by controlling the frequency of the C1FP character. The most frequent transmission of the C1FP character is every four SBI336S frame times. This is the SBI336S multiframe and is used when there are no synchronous tributaries requiring signaling multiframe alignment on the SBI336S bus. When there are synchronous tributaries requiring signaling multiframe alignment on the SBI336S bus the C1FP character is transmitted every 48 frame times. This is the CAS signaling multiframe and is the lowest common multiple of the 24 frame T1 multiframe and the 16 frame E1 multiframe.

The SBI336S multiframe and signaling multiframe alignment is based on a free running multiframe counter that is reset with each C1FP character received. Under normal operating conditions each received C1FP character will coincide with the free running multiframe counter. SBI336S multiframe alignment is always required, SBI336S signaling multiframe alignment is optional and only required when synchronous tributaries are supported.

SBI336S Character Encoding

Table 32 shows the mapping of SBI336S bus control bytes and signals into 8B/10B control characters. The table is divided into three sections, one for each software configurable mode of operation. The Linkrate octet in location V4, the in-band programming channel, and the V3 octet when it contains data are all carried as data. Justification requests for master timing are carried in the V5 character so there are three V5 characters used: nominal, negative timing adjustment request, and positive timing adjustment request.

TABLE 32
SBI336S Special Character Encoding

| | | | |
|---|---|---|---|
| Code Group | Curr. RD− | Curr. RD+ | Decoded Signals |
| Name | abcdei fghj | abcdei fghj | Description |

Common to All Link Types

| | | | |
|---|---|---|---|
| K28.5− | 001111 1010 | 110000 0101 | C1FP frame and multiframe |
| | | | alignment |
| | | | DATA[7:0] = ′h01 |
| K23.7− | 111010 1000 | — | Overhead Bytes (columns 1- |
| | | | 60 or 1-72 except for C1 |
| | | | and in-band programming |
| | | | channel), V3 or H3 byte |
| | | | except during negative |
| | | | justification, byte after |
| | | | V3 or H3 byte during |
| | | | positive justification, |
| | | | unused bytes in fraction |
| | | | rate links |
| | | | DATA[7:0] = ′h00 |

Asynchronous T1/E1 Links

| | | | |
|---|---|---|---|
| K27.7− | 110110 1000 | — | V5 byte, no justification |
| | | | request |
| K28.7− | 001111 1000 | — | V5 byte, negative |
| | | | justification request |
| K29.7− | 101110 1000 | — | V5 byte, positive |
| | | | justification request |

Synchronous T1/E1 Links

| | | | |
|---|---|---|---|
| K27.7− | 110110 1000 | — | V5 byte |

Asynchronous DS3/E3 Links

| | | | |
|---|---|---|---|
| K27.7− | 110110 1000 | — | V5 byte, no justification |
| | | | request |
| K28.7− | 001111 1000 | — | V5 byte, negative |
| | | | justification request* |
| K29.7− | 101110 1000 | — | V5 byte, positive |
| | | | justification request* |

Fractional Rate Links

| | | | |
|---|---|---|---|
| K28.7− | 001111 1000 | — | V5 byte, send one extra |
| | | | byte request** |
| K29.7− | 101110 1000 | — | V5 byte, send one less |
| | | | byte request** |

Floating Transparent Virtual Tributaries

| | | | |
|---|---|---|---|
| K27.7− | 110110 1000 | — | V5 byte |
| | | | OD[0,4] = ERDI[1:0] = |
| | | | ′b00, OD[5] = REI = ′b0 |
| | | | OD[7,6,3:1] = ′b00000 |
| K27.7+ | — | 001001 0111 | V5 byte |
| | | | OD[0,4] = ERDI[1:0] = |
| | | | ′b00, OD[5] = REI = ′b1 |
| | | | OD[7,6,3:1] = ′b00000 |
| K28.7− | 001111 1000 | — | V5 byte |
| | | | OD[0,4] = ERDI[1:0] = |
| | | | ′b01, OD[5] = REI = ′b0 |
| | | | OD[7,6,3:1] = ′b00000 |
| K28.7+ | — | 110000 0111 | V5 byte |
| | | | OD[0,4] = ERDI[1:0] = |
| | | | ′b01, OD[5] = REI = ′b1 |
| | | | OD[7,6,3:1] = ′b00000 |
| K29.7− | 101110 1000 | — | V5 byte |
| | | | OD[0,4] = ERDI[1:0] = |
| | | | ′b10, OD[5] = REI = ′b0 |
| | | | OD[7,6,3:1] = ′b00000 |
| K29.7+ | — | 010001 0111 | V5 byte |
| | | | OD[0,4] = ERDI[1:0] = |
| | | | ′b10, OD[5] = REI = ′b1 |
| | | | OD[7,6,3:1] = ′b00000 |
| K30.7− | 011110 1000 | — | V5 byte |
| | | | OD[0,4] = ERDI[1:0] = |
| | | | ′b11, OD[5] = REI = ′b0 |
| | | | OD[7,6,3:1] = ′b00000 |
| K30.7+ | — | 100001 0111 | V5 byte |
| | | | OD[0,4] = ERDI[1:0] = |
| | | | ′b11, OD[5] = REI = ′b1 |
| | | | OD[7,6,3:1] = ′b00000 |

*Note:
there can be multiple V5s per SBI frame when in DS3 or E3 mode but only one justification can occur per SBI frame. Positive and negative justification request through V5 required by the SBI336S interface should be limited to one per frame.
**Note:
Fractional rate links must be near symmetric in the transmit and receive direction over SBI336S. When using clock slave mode with a Fractional rate link the clock master makes single byte adjustments to the slaves rate once per frame.

Error Detection

8B/10B Line Code Violations (LCVs) are continuously monitored and will be used to detect errors on the SBI336S link. The control characters (K28.0, K28.4, K38.7, K23.7, K27.7, K28.7, K29.7 and K30.7) are treated specially and are not considered LCVs.

In-Band Communication Channel

The SBI336S allows for an in-band communications channel between devices at either end of the serial bus. This is a full duplex channel with error detection between microprocessors at either end of the link.

The in-band channel is carried in the first 36 columns of four rows of the SBI structure, rows 3, 6, 7 and 8. The overall in-band channel capacity is thus 36*4*64 kb/s=9.216 Mb/s. Each 36 bytes per row allocated to the in-band signaling channel is its own in-band message between the end points. Four bytes of each 36-byte in-band message are reserved for end-to-end control information and error protection, leaving 8.192 Mb/s available for data transfer between the end points.

The data transferred between the end points has no fixed format, effectively providing a clear channel for packet transfer between the attached microprocessors at each end of the SBI336S link terminating devices. The user is able to send and receive any packet up to 32 bytes in length. The last two reserved bytes of the 36-byte in-band message form a CRC-16 (X¹⁶+X¹⁵+X²+X¹), which detects errors in the message.

In-Band Channel Fixed Overhead

The in-Band channel includes two bytes of fixed header and a CRC-16 per every 36-byte in-band message. The two-byte header provides control and status between devices at the ends of the LVDS link. The CRC-16 is calculated over the entire 34-byte in-band message and provides the terminating end the ability to detect errors in the in-band message. The format of the in-band message and header bytes is shown in Table 33 and Table 34. A description of the header fields is provided in Table 35.

TABLE 33
In-Band Channel Message Format

| 1 byte | 1 byte | 32 bytes | 2 bytes |
|---|---|---|---|
| Header1 | Header2 | Free Format Information | CRC-16 |

TABLE 34
In-Band Channel Header Format
Header1

| | | | | | | | |
|---|---|---|---|---|---|---|---|
| Bit 7 | Bit 6 | Bit 5 | Bit 4 | Bit 3 | Bit 2 | Bit 1 | Bit 0 |

| | | | |
|---|---|---|---|
| Valid | Link[1:0] | Page[2:0] | User [2:0] |

Header2

| | | | | | | | |
|---|---|---|---|---|---|---|---|
| Bit 7 | Bit 6 | Bit 5 | Bit 4 | Bit 3 | Bit 2 | Bit 1 | Bit 0 |

Aux [7:0]

TABLE 35
In-band Message Header Fields

| Field Name | Description |
|---|---|
| Valid | Message slot contains a message (1) or is |
| | empty (0). |
| Link[1:0]* | These bits are optional for SBI336S devices, |
| | intended for devices which have multiple |
| | redundant links. Each bit either indicates which |
| | Link to use, working (0) or Protect(1) when |
| | sourced from the master device, or which link is |
| | being used, when sourced from the slave device. |
| Page[1:0]* | These bits are optional for SBI336S devices, |
| | intended for devices which have multiple |
| | configuration pages. These bits indicate which |
| | control page to use, page (1) or page (0) when |
| | sourced from the master device, or which page is |
| | being used, when sourced from the slave device. |
| | The two Page bits allow for independent pages in |
| | both the ingress and egress direction. |
| User[2:0]* | User defined indication between devices. |
| Aux[7:0]* | User defined auxiliary field between devices. |

*These bits are optional but if used must adhere to the Link, Page, User and Aux fields. When used these should also be able to be disabled.

There is no inherent flow control provided. The attached microprocessor utilizing this in-band channel is able to provide flow control via interrupts and via the User[2:0] bits in the header. The User[2:0] bits can each carry a single bit of information across the SBI336S link.

As each message arrives, the CRC-16 and Valid bit is checked; if the Valid bit is not set the message is discarded, if it fails the CRC check the message is flagged as being in error. If the CRC-16 is OK, regardless of the Valid bit, the Page Link, User and Aux bits should be forwarded immediately.

This specification covers an interface for interconnection of asynchronous and synchronous PHY devices with Link Layer devices. This interface is intended to fulfill the need of system designers to flexibly interconnect high-density multi-port PHY devices in a standardized way with multi-channel and multi-function Link Layer devices. This includes high density switching devices that may be connected between the PHY and Link Layer devices. As a result, the SBI336S is intended to allow the interconnection of PHY devices, including channelized framers, with Link Layer devices of widely varying channel densities and payload types.

The SBI336S is further intended to be a higher density alternative for existing synchronous computer telephony buses.

Accordingly, while this invention has been described with reference to illustrative embodiments, this description is not intended to be construed in a limiting sense. Various modifications of the illustrative embodiments, as well as other embodiments of the invention, will be apparent to persons skilled in the art upon reference to this description. It is therefore contemplated that the appended claims will cover any such modifications or embodiments as fall within the scope of the invention.

What is claimed:

1. A serial scaleable bandwidth interconnect bus for interconnection of physical layer and link layer devices, comprising:
(a) an ADD Bus operative to receive signals from said link layer devices and direct them to said physical layer devices; and
(b) a DROP Bus operative to receive signals from said physical layer devices and direct them to said link layer devices;
wherein said serial scaleable bandwidth interconnect bus is capable of supporting a plurality of links; and
wherein, for one or more of said links, ADD Bus timing control information is conveyed from said physical layer to said link layer in-band of said DROP Bus and independently of other ones of said links.

2. The interconnect bus according to claim 1, wherein said timing control information is 8B/10B encoded.

3. The interconnect bus according to claim 1, wherein said bus interface device supports fractional links.

4. The interconnect bus according to claim 1, wherein a bandwidth of each of said fractional links is an arbitary rate up to a maximum of approximately 45 MB/s.

5. The interconnect bus according to claim 1, wherein said bus interface device supports T1s, E1s, TVT1.5s, TVT2s, DS3s, E3s or fractional links.

6. The interconnect bus according to claim 1, wherein said bus interface device supports 336 T1s, 252 E1s, 336 TVT1.5s, 252 TVT2s, 12 DS3s, 12E3s or 12 fractional links.

7. The interconnect bus according to claim 1, wherein said bus interface device is scaleable by increasing a serial interconnect rate in multiples of four.

8. The interconnect bus according to claim 1, wherein said bus interface device interconnects asynchronous and synchronous physical and link layer devices.

9. The interconnect bus according to claim 1, wherein said bus interface device is a LVDS interface.

10. The interconnect bus according to claim 1, wherein said DROP Bus comprises an in-band half-duplex channel for conveying control information between said physical layer and said link layer.

11. The interconnect bus according to claim 1, wherein said ADD Bus comprises a n in-band half-duplex channel for conveying control information between said physical layer and said link layer.

12. An apparatus for providing a bus interface for interconnection of physical layer and link layer devices, comprising:
(a) an ADD Bus operative to receive signals from said link layer devices and direct them to said physical layer devices; and
(b) a DROP Bus operative to receive signals from said physical layer devices and direct them to said link layer devices;
wherein said apparatus is capable of supporting a plurality of links; and
wherein, for one or more of said links, ADD Bus timing control information is conveyed from said physical layer to said link layer in-band of said DROP Bus and independently of other ones of said links.

13. The apparatus according to claim 12, wherein said timing control information is 8B/10B encoded.

14. The apparatus according to claim 12, wherein said bus interface supports fractional links.

15. The apparatus according to claim 14, wherein a bandwidth of each of said fractional links is an arbitrary rate up to a maximum of approximately 45 MB/s.

16. The apparatus according to claim 12, wherein said bus interface supports T1s, E1s, TVT1.5s, TVT2s, DS3s, E3s or fractional links.

17. The apparatus according to claim 12, wherein said bus interface supports 336 T1s, 252 E1s, 336 TVT1.5s, 252 TVT2s, 12 DS3s, 12E3s or 12 fractional links.

18. The apparatus according to claim 12, wherein said bus interface is scaleable by increasing a serial interconnect rate in multiples of four.

19. The apparatus according to claim 12, wherein said bus interface interconnects asynchronous and synchronous physical and link layer devices.

20. The apparatus according to claim 12, wherein said bus interface is a LVDS interface.

21. The apparatus according to claim 12, wherein said DROP Bus comprises an in-band half-duplex channel for conveying control information between said physical layer and said link layer.

22. The apparatus according to claim 12, wherein said ADD Bus comprises an in-band half-duplex channel for conveying control information between said physical layer and said link layer.

23. A method for connecting one or more Physical Layer devices with one or more link Layer devices, comprising:
(a) providing an ADD Bus operative to receive signals from said link layer devices and direct them to said physical layer devices; and
(b) providing a DROP Bus operative to receive signals from said physical layer devices and direct them to said link layer devices;
wherein said ADD Bus and said DROP Bus are capable of supporting a plurality of links; and
wherein, for one or more of said links, ADD Bus timing control information is conveyed from said physical layer to said link layer in-band of said DROP Bus and independently of other ones of said links.

24. The method of claim 23, wherein said timing control information is 8B/10B encoded.

25. The method of claim 23, wherein said ADD Bus and said DROP Bus support fractional links.

26. The method of claim 25, wherein a bandwidth of each of said fractional links is an arbitrary rate up to a maximum of approximately 45 MB/s.

27. The method of claim 23, wherein said ADD Bus and said DROP Bus support T1s, E1s, TVT1.5s, TVT2s, DS3s, E3s or fractional links.

28. The method of claim 23, wherein said ADD Bus and said DROP Bus support 336 T1s, 252 E1s, 336 TVT1.5s, 252 TVT2s, 12 DS3s, 12E3s or 12 fractional links.

29. The method of claim 23, wherein said ADD Bus and said DROP Bus interconnect asynchronous and synchronous physical and link layer devices.

30. The method of claim 23, wherein said DROP Bus comprises an in-band half-duplex channel for conveying control information between said physical layer and said link layer.

31. The method of claim 23, wherein said ADD Bus comprises an in-band half-duplex channel for conveying control information between said physical layer and said link layer.
